(19) United States
(12) Patent Application Publication
(10) Pub. No.: US 2025/0049140 A1
(43) Pub. Date: Feb. 13, 2025

(54) AEROSOL-GENERATING SYSTEM WITH TAGGANT IDENTIFICATION

(71) Applicant: Philip Morris Products S.A., Neuchatel (CH)

(72) Inventors: Michel BESSANT, Neuchatel (CH); Stéphane BILAT, Cortaillod (CH); Fabrice STEFFEN, Colombier (CH)

(73) Assignee: Philip Morris Products S.A., Neuchatel (CH)

(21) Appl. No.: 18/707,054

(22) PCT Filed: Nov. 9, 2022
(86) PCT No.: PCT/EP2022/081352

§ 371 Date: May 2, 2024

(30) Foreign Application Priority Data
Nov. 9, 2021 (WO) PCT/CN2021/129558

(51) Int. Cl. A24F 40/53; A24F 40/40

(52) U.S. Cl. CPC A24F 40/53; A24F 40/40

(57) ABSTRACT

A method of controlling an aerosol-generating system is provided, the system including: an aerosol-generating article including a taggant having an identifiable spectroscopic signature and being excitable by light to emit a light emission, and an aerosol-generating device configured to engage with, and disengage from, the article, the device including: a light source to illuminate the article engaged with the device, and a light receiver to receive light emitted by the article engaged with device; and the method including: illuminating, by the light source, the article engaged with the device so as to excite the taggant to emit the light emission, ending the illuminating, by the light source, of the article, receiving, by the light receiver, the light emission after the light source ending the illuminating, and analysing the light emission received by the light receiver to determine a characteristic of the article.

The present disclosure relates to a method of controlling an aerosol-generating system. The present disclosure also relates to an aerosol-generating device. The present disclosure also relates to a controller for an aerosol-generating device.

An aerosol-generating system typically comprises an aerosol-generating device and an aerosol-generating article. In use, the aerosol-generating article is engaged with the aerosol-generating device, and a heater of the aerosol-generating system, for example of the device, heats an aerosol-forming substrate having an aerosol-former of the aerosol-generating article so as to generate an aerosol. That generated aerosol may then be carried via an airflow path to a mouthpiece or air outlet of the device or article. The aerosol may be for inhalation by a user.

Some aerosol-generating devices may be useable with lots of different aerosol-generating articles but provide a better or safer user experience when used with particular aerosol-generating articles. For example, some aerosol-generating devices may be configured to heat a particular aerosol-generating article in a particular way, or for a particular length of time, or to a particular temperature range, in order to provide an optimal experience for the user. As such, it would be beneficial to prevent or discourage users from being able to use some aerosol-generating articles with some aerosol-generating devices.

According to the present disclosure, there is provided a method of controlling an aerosol-generating system. The system may comprise an aerosol-generating article. The article may comprise a taggant. The taggant may have an identifiable spectroscopic signature. The taggant may be excitable by light to emit a light emission. The system may comprise an aerosol-generating device. The device may be configured to engage with, and disengage from, the aerosol-generating article. The device may comprise a light source, for example for illuminating an aerosol-generating article engaged with the device. The device may comprise a light receiver, for example for receiving light emitted by an aerosol-generating article engaged with the device. The method may comprise the light source illuminating the aerosol-generating article engaged with the aerosol-generating device, for example so as to excite the taggant to emit the light emission. The method may comprise the light source ending illuminating the aerosol-generating article engaged with the aerosol-generating device. The method may comprise the light receiver receiving the light emission, optionally after the light source ending illuminating the aerosol-generating article. The method may comprise analysing the light emission received by the light receiver, for example to identify the spectroscopic signature of the taggant and optionally to determine a characteristic of the aerosol-generating article.

According to a first aspect of the present disclosure, there is provided a method of controlling an aerosol-generating system. The system comprises an aerosol-generating article comprising a taggant having an identifiable spectroscopic signature, the taggant being excitable by light to emit a light emission, and an aerosol-generating device configured to engage with, and disengage from, the aerosol-generating article, the device comprises a light source for illuminating an aerosol-generating article engaged with the device, and a light receiver for receiving light emitted by an aerosol-generating article engaged with the device. The method comprises the light source illuminating the aerosol-generating article engaged with the aerosol-generating device so as to excite the taggant to emit the light emission, the light source ending illuminating the aerosol-generating article engaged with the aerosol-generating device, the light receiver receiving the light emission after the light source ending illuminating the aerosol-generating article, and analysing the light emission received by the light receiver to determine one or more characteristics of the aerosol-generating article.

Advantageously, by ending the light source illuminating the article before analysing the light emission received by the light receiver, the analysis may focus exclusively on the time response, also sometimes referred to as a decay rate, of the taggant. This may provide an accurate and reliable way to determine one or more characteristics of the aerosol-generating article.

Advantageously, the method may utilise the time response of the excited taggant to determine one or more characteristics of the aerosol-generating article. Specifically, the method may determine various characteristics of the time response, such as how an intensity, or a time derivative of intensity, of the light emission from the excited taggant varies over time, and then may compare these characteristics with stored data, for example stored data comprising expected or reference characteristics, in order to determine one or more characteristics of the aerosol-generating article. This is explained in more detail later.

The method may comprise determining one or more characteristics of the aerosol-generating article. One characteristic of the article which may be determined is whether or not the article is configured, designed, or in some way optimised for use with the device. An article which is configured, designed, or in some way optimised for use with the device may be referred to as an optimised article. An article which is not configured, designed, or in some way optimised for use with the device may be referred to as a non-optimised article. Thus, determining a characteristic of the article may comprise determining whether or not the article is an optimised article.

Other characteristics of the article which may be determined include the aerosol-generating article type, the aerosol-forming substrate type, the date of production, the place of production, the batch number, other production details, and the use-by-date.

The method may comprise enabling or disabling a function of the aerosol-generating device, for example enabling or disabling heating of a heater of the system, depending on one or both of the spectroscopic signature of the taggant and one or more determined characteristics of the aerosol-generating article. Thus, advantageously, the method may reduce a likelihood of a user using a non-optimised article with the device. This may help to ensure an optimised experience for the user.

The method may comprise adjusting a function of the system, for example adjusting a heating profile of a heater of the system during a heating phase, depending on one or both of the identified spectroscopic signature of the taggant and one or more determined characteristics of the aerosol-generating article. Thus, advantageously, the method may allow the system to optimise an experience for the user.

The article may comprise an aerosol-forming substrate. The aerosol-forming substrate may be a solid aerosol-forming substrate. The aerosol-forming substrate may be a gel. The aerosol-forming substrate may be a liquid.

As used herein, the term “aerosol-forming substrate” may refer to a substrate capable of releasing volatile compounds that can form an aerosol. The volatile compounds may be released by heating or combusting the aerosol-forming substrate.

The aerosol-forming substrate may comprise a pharmaceutically active agent. The aerosol-forming substrate may comprise combinations of pharmaceutically active agents. The aerosol-forming substrate may comprise nicotine. The aerosol-forming substrate may comprise plant-based material. The aerosol-forming substrate may comprise homogenised plant-based material. The aerosol-forming substrate may comprise tobacco. The aerosol-forming substrate may comprise a tobacco-containing material. The tobacco-containing material may contain volatile tobacco flavour compounds. These compounds may be released from the aerosol-forming substrate upon heating. The aerosol-forming substrate may comprise homogenised tobacco material. The aerosol-forming substrate may comprise other additives and ingredients, such as flavourants. The liquid aerosol-forming substrate may comprise one or more of water, solvents, ethanol, plant extracts and natural or artificial flavours. The aerosol-forming substrate may comprise an aerosol former. Examples of suitable aerosol formers are glycerine, glycerol, and propylene glycol.

The aerosol-generating article may comprise a hollow tubular element. The aerosol-generating article may comprise an aerosol cooling element. The aerosol-generating article may comprise a mouthpiece. The aerosol-generating article may comprise an outer wrapper, for example a paper wrapper.

The aerosol-generating article may comprise an aerosol-forming substrate, a hollow tubular element, an aerosol cooling element and a mouthpiece arranged sequentially in co-axial alignment and circumscribed by an outer wrapper.

The device may comprise a housing. The aerosol-generating device may comprise a cavity. The housing may define the cavity. The housing may be configured to be held in use. The cavity may be for receiving at least a portion of the aerosol-generating article. Engaging the article with the device may be or comprise receiving at least a portion of the article in the cavity of the device.

The device may comprise an air inlet. For example, the housing may define the air inlet. An air flow path may be formed from the air inlet to the cavity of the device. The air flow path may be formed from an air inlet to the cavity of the device, to an air outlet.

The device may comprise a power supply, for example for supplying power to the electrical components of the device. The device may comprise a controller. The controller may be coupled to the power supply. The controller may control the supply of power from the power supply to the electrical components of the device.

The system may comprise a heater. The heater may comprise a heating element. The heater may comprise a means for heating the heating element.

The device may comprise the heater. The device may comprise a heating element in the form of pin, blade, or rod. The heating element may be electrically connected to the power supply. The heating element of the device may extend longitudinally in the cavity, for example from a base of a chamber defining the cavity. The heating element may be configured to penetrate an aerosol-forming substrate of an aerosol-generating article in use. The heating element may be configured to penetrate the aerosol-forming substrate of the article when the article is received in the cavity. The heating element may be a resistive heating element to heat the aerosol-generating article. The heating element may be an inductive heating element or susceptor, designed to be magnetically coupled with a coil in the device for generating a magnetic field to heat the susceptor, and to heat the aerosol-generating article.

The article may comprise an air outlet. For example, a mouthpiece of the article may comprise the air outlet.

When the article is engaged with the device, an air flow path may be defined between the air inlet and the air outlet. In use, a user may inhale on an article received in a cavity of the device, and this inhalation may cause air to flow through the air inlet of the device, then into the cavity of the device, then through the article engaged with the device, then out through the air outlet of the mouthpiece of the article, and then into the mouth of the user.

In use, an article may be engaged with the device, for example received in the cavity of the device. As the article is received in the cavity, a heating element, for example in the form of a heating blade extending longitudinally from a base of the cavity, may penetrate an aerosol-forming substrate of the article. The user may then press a button to cause the light source of the device to temporarily illuminate the article so as to excite the taggant to emit the light emission. After this illumination has ended, the light receiver may then receive the light emission. The light emission received by the light receiver may then be analysed to determine a characteristic of the aerosol-generating article. This analysis may determine, for example, that the article is suitable for use with the device. In response, the device may enable or disable a function of the device. For example, the device may therefore allow operation of the heating element. A user may then inhale on a mouthpiece of the article. This may cause air to flow through the air inlet of the device. This air flow may be detected by a puff detection mechanism of the device. This may cause operation of the heating element. Alternatively, the heating element may be manually activated by a user, for example using a button. The heating element may then heat up. This may heat up the aerosol-forming substrate of the article such that volatile compounds are released by the aerosol-forming substrate. The user inhalation may cause the air flow through the air inlet to then flow through the aerosol-forming substrate. The volatile compounds released by the aerosol-forming substrate may be entrained in the air flow. The air and entrained compounds may then flow through the hollow tubular element, and the aerosol cooling element. During this time, the volatile compounds may cool and condense to form an aerosol. The aerosol may then flow through the mouthpiece of the article and into the mouth of the user.

As would be understood by the skilled person after reading this disclosure, the above paragraph describes use of a particular system, but other systems may implement the invention.

The method, for example the step of analysing the light emission received by the light receiver, may comprise analysing an intensity of the light emission over time. Advantageously, analysing an intensity of the light emission over time may provide an accurate and reliable way to determine one or more characteristics of the aerosol-generating article.

As used herein, the term “intensity” may refer to, or be indicative of, a power. Intensity may be measured in Watts.

The method, for example the step of analysing the light emission received by the light receiver, may comprise analysing at least one time derivative of intensity of the light emission over time. Advantageously, analysing a time derivative of intensity of the light emission over time may provide an accurate and reliable way to determine one or more characteristics of the aerosol-generating article.

As used herein, the term “time derivative of intensity” may refer to any derivative of intensity with respect to time. The term “intensity time derivative” may be used to mean the same thing. As used herein, the terms “time nth derivative of intensity” or “intensity time nth derivative” may refer to an nth derivative of intensity with respect to time. For example, the terms “time first derivative of intensity” and “intensity time first derivative” may refer to a first derivative of intensity with respect to time, which may be a rate of change of intensity with respect to time. The terms “time second derivative of intensity” and “intensity time second derivative” may refer to a second derivative of intensity with respect to time, which may be a rate of change of a rate of change of intensity with respect to time. The terms “time greater than second derivative of intensity” and “intensity time greater than second derivative” may be a third or greater derivative of intensity with respect to time.

The intensity of the light emission, V, at any given time, t, may be written mathematically as:

intensity=V(t)

As such, the time first derivative of intensity at any given time may be written mathematically as:

$$time first derivative of intensity = \frac{dV ( t )}{dt} = {V}^{′} ( t )$$

And the time second derivative of intensity at any given time may be written mathematically as:

$$time second derivative of intensity = \frac{{d}^{2} V ( t )}{{dt}^{2}} = {V}^{″} ( t )$$

The method, for example the step of analysing the light emission received by the light receiver, may comprise analysing, or calculating and analysing, a time first derivative of intensity of the light emission over time. The method, for example the step of analysing the light emission received by the light receiver, may comprise analysing, or calculating and analysing, a time second derivative of intensity of the light emission over time. The method, for example the step of analysing the light emission received by the light receiver, may comprise analysing, or calculating and analysing, a time greater than second derivative of intensity of the light emission over time.

The method, for example the step of analysing the light emission received by the light receiver, may comprise analysing multiple time derivatives of intensity of the light emission over time. For example, the method, for example the step of analysing the light emission received by the light receiver, may comprise analysing both a time first derivative of intensity of the light emission over time and a time second derivative of intensity of the light emission over time. As a second example, the method, for example the step of analysing the light emission received by the light receiver, may comprise analysing both a time first derivative of intensity of the light emission over time and a time greater than second derivative of intensity of the light emission over time. As a third example, the method, for example the step of analysing the light emission received by the light receiver, may comprise analysing both a time second derivative of intensity of the light emission over time and a time greater than second derivative of intensity of the light emission over time.

Advantageously, analysing multiple time derivatives of intensity of the light emission over time may improve the accuracy and reliability of determining one or more characteristics of the aerosol-generating article.

The method, for example the step of analysing the light emission received by the light receiver, may comprise analysing both an intensity of the light emission over time and at least one time derivative of intensity of the light emission over time. For example, the method, for example the step of analysing the light emission received by the light receiver, may comprise analysing both an intensity of the light emission over time and a time first derivative of intensity of the light emission over time. As a second example, the method, for example the step of analysing the light emission received by the light receiver, may comprise analysing both an intensity of the light emission over time and a time second derivative of intensity of the light emission over time. As a third example, the method, for example the step of analysing the light emission received by the light receiver, may comprise analysing both an intensity of the light emission over time and a time greater than second derivative of intensity of the light emission over time.

Advantageously, analysing both an intensity of the light emission over time and at least one time derivative of intensity of the light emission over time may improve the accuracy and reliability of determining one or more characteristics of the aerosol-generating article.

The method, for example the step of analysing the light emission received by the light receiver, may comprise analysing an intensity of the light emission over time and multiple time derivatives of intensity of the light emission over time. For example, the method, for example the step of analysing the light emission received by the light receiver, may comprise analysing an intensity of the light emission over time, a time first derivative of intensity of the light emission over time, and a time second derivative of intensity of the light emission over time. As a second example, the method, for example the step of analysing the light emission received by the light receiver, may comprise analysing an intensity of the light emission over time, a time first derivative of intensity of the light emission over time, and a time greater than second derivative of intensity of the light emission over time. As a third example, the method, for example the step of analysing the light emission received by the light receiver, may comprise analysing an intensity of the light emission over time, a time second derivative of intensity of the light emission over time, and a time greater than second derivative of intensity of the light emission over time. As a fourth example, the method, for example the step of analysing the light emission received by the light receiver, may comprise analysing an intensity of the light emission over time, a time first derivative of intensity of the light emission over time, a time second derivative of intensity of the light emission over time, and a time greater than second derivative of intensity of the light emission over time.

Advantageously, analysing an intensity of the light emission over time and multiple time derivatives of intensity of the light emission over time may improve the accuracy and reliability of determining one or more characteristics of the aerosol-generating article.

The method, for example the step of analysing the light emission received by the light receiver, may comprise converting the light emission received by the light receiver into an electrical signal, for example a voltage or current signal, indicative of an intensity of the light emission over time. The value of the electrical signal at any given time may be proportional to the intensity of the light emission at that time. This may be achieved by the light receiver. For example, the light receiver, which may be a photodiode, may convert the light emission received by the light receiver into an electrical signal, for example a voltage or current signal, indicative of, for example proportional to, an intensity of the light emission over time. Advantageously, this may simplify analysis of the light emission.

The method, for example the step of analysing the light emission received by the light receiver, may comprise converting the light emission received by the light receiver, or the electrical signal indicative of an intensity of the light emission over time, into a digital signal indicative of an intensity of the light emission over time. The value of the digital signal at any given time may be proportional to the intensity of the light emission at that time. Advantageously, this may simplify analysis of the light emission.

The method, for example the step of analysing the light emission received by the light receiver, may comprise normalising a magnitude of the light emission received by the light receiver. Analysing the light emission received by the light receiver may comprise normalising a magnitude of the electrical signal indicative of an intensity of the light emission over time. Analysing the light emission received by the light receiver may comprise normalising a magnitude of the digital signal indicative of an intensity of the light emission over time.

Normalising a magnitude of an emission or signal may comprise setting a maximum magnitude. Normalising a magnitude of an emission or signal may comprise setting any magnitudes of the emission or signal greater than a predetermined magnitude to a maximum magnitude. Normalising a magnitude of an emission or signal may comprise setting an initial magnitude of the emission or signal to a predetermined magnitude.

Advantageously, normalising a magnitude of an emission or signal may allow the analysis to remain accurate regardless of the relative intensities of light emissions from the article. This may be important, for example, if the light source begins to lose charge and illuminates the article a lesser amount, and causes the subsequent light emission to be less intense.

The method, for example the step of analysing the light emission received by the light receiver, may comprise determining a value indicative of an intensity of the light emission at each of a plurality of time points, and optionally recording each of these values. This may comprise, for example, recording a value, for example a voltage or current value, of the electrical signal, the value being indicative of an intensity of the light emission at each of a plurality of time points.

The time points may be written mathematically as tₙ. The first time point may be written mathematically as tᵢₙᵢₜᵢₐₗ or t₀. The final time point may be written as t_{final}. A value indicative of the intensity of the light emission at any time point may be written as V(tₙ). A value indicative of a time first derivative of intensity of the light emission at any time point may be written as V′(tₙ). A value indicative of a time second derivative intensity of the light emission at any time point may be written as V″(tₙ).

The values indicative of a time derivative of intensity of the light emission at any time point may be calculated or estimated based on the recorded values indicative of the intensity of the light emission. For example, the values indicative of a time first derivative of intensity of the light emission at any time point may be calculated or estimated using the following equation:

$${V}^{′} ( {t}_{n} ) = \frac{V ( {t}_{n + 1} ) - V ( {t}_{n} )}{( {t}_{n + 1} ) - ( {t}_{n} )}$$

And the values indicative of a time second derivative of intensity of the light emission at any time point may be calculated or estimated using the following equation:

$${V}^{″} ( {t}_{n} ) = \frac{{V}^{′} ( {t}_{n + 1} ) - {V}^{′} ( {t}_{n} )}{( {t}_{n + 1} ) - ( {t}_{n} )}$$

As would be understood in the art, these are merely examples and the values could be calculated or estimated in many other ways.

The plurality of time points may comprise at least 10, 20, 50, 100, 200, 500, or 1,000 time points. Advantageously, a greater number of time points may increase an accuracy and reliability of identifying the spectroscopic signature of the taggant.

The time points may occur at regular time intervals. The time points may occur at time intervals, for example regular time intervals, of at least 1, 2, 5, 10, 20, or 50 microseconds. The time points may occur at time intervals, for example regular time intervals, of no more than 100, 50, 20, 10, 5, or 2 microseconds. The time points may occur at time intervals, for example regular time intervals, of between 1 and 100 microseconds. Advantageously, such time intervals may adequately capture the time response of the light emission without requiring determination of an unnecessarily large number of values.

The time period over which the plurality of time points occur may be no more than 2,000, 1,000, 500, 200, 100, 50, 20, 10, 5, 2, 1, 0.9, or 0.5 milliseconds. Advantageously, such a time period may allow the system to adequately capture the time response of the light emission without requiring determination of an unnecessarily large number of values.

The method, for example the step of analysing the light emission received by the light receiver, may comprise calculating or otherwise providing a combination of the values indicative of the intensity of the light emission at each of the plurality of time points. The combination of the values indicative of the intensity of the light emission at each of the plurality of time points may be referred to as an intensity combination. Analysing the light emission received by the light receiver may comprise calculating or otherwise providing an intensity score, for example based on the intensity combination. The intensity score may be obtained by comparing the intensity combination with stored data, as explained in more detail below. Advantageously, the use of such an intensity score may provide an accurate and reliable indication of the spectroscopic signature of the taggant.

The intensity combination, like other combinations described herein, may be based on a summation, multiplication, integral, or other function, of the values indicative of the intensity of the light emission at each of the plurality of time points.

For example, the intensity combination may be calculated by summing each of the values indicative of the intensity of the light emission at each of the plurality of time points. This may be written mathematically as:

$$intensity combination = {\sum }_{{t}_{n} = {t}_{initial} = {t}_{0}}^{{t}_{n} = {t}_{final}} V ( {t}_{n} ) = V ( {t}_{0} ) + V ( {t}_{1} ) + V ( {t}_{2} ) … + V ( {t}_{final} )$$

where V(tₙ) is the value of the intensity of the light emission at any given time point tₙ, tᵢₙᵢₜᵢₐₗ is the first time point of the plurality of time points over which the V(tₙ) values are summed, and t_{final} is the final time point of the plurality of time points over which the V(tₙ) values are summed.

The intensity combination, like other combinations described herein, may be based on an integral or an estimate of an integral. For example, the intensity combination may be based on an estimate of an integral of a function formed by plotting the values indicative of the intensity of the light emission at each of the plurality of time points against time. In this context, the term “integral” may take its usual mathematical meaning. Thus, the integral of a function between two limits may refer to a number equal to the area between the function and the x-axis of a graph on which the function is plotted. There are a number of ways of estimating such an integral. One way may include summing a number of smaller areas, for example using the following equation:

$$\begin{matrix}intensity combination = {\sum }_{{t}_{n} = {t}_{initial} = {t}_{0}}^{{t}_{n} = tfinal - 1} V ( {t}_{n} ) . [ ( {t}_{n + 1} ) - ( {t}_{n} ) ] \\ = V ( {t}_{0} ) . [ ( {t}_{1} ) - ( {t}_{0} ) ] + V ( {t}_{1} ) . [ ( {t}_{2} ) - ( {t}_{1} ) ] … + \\ V ( {t}_{final - 1} ) . [ ( {t}_{final} ) - ( {t}_{final - 1} ) ]\end{matrix}$$

Where the plurality of time points are regular, and thus have regular time intervals of tint, the above equation may be simplified and written as:

$$\begin{matrix}intensity combination = {\sum }_{{t}_{n} = {t}_{initial} = {t}_{0}}^{{t}_{n} = tfinal - 1} V ( {t}_{n} ) . [ {t}_{int} ] \\ = V ( {t}_{0} ) . [ {t}_{int} ] + V ( {t}_{1} ) . [ {t}_{int} ] … + V ( {t}_{final - 1} ) . [ {t}_{int} ]\end{matrix}$$

In the above equations, a full stop is used to indicate multiplication.

As would be understood by the skilled person after reading this disclosure, other combinations, such as intensity time derivative combinations, may be calculated or estimated in a similar manner. For example, an estimate of an intensity time first derivative combination could be calculated as:

$$intensity time first derivative combination = {\sum }_{{t}_{n} = {t}_{initial} = {t}_{0}}^{{t}_{n} = tfinal - 1} {V}^{′} ( {t}_{n} ) . [ ( {t}_{n + 1} ) - ( {t}_{n} ) ]$$

where V′ (tₙ) is the value indicative of the time first derivative of intensity of the light emission at any given time point tₙ, tᵢₙᵢₜᵢₐₗ is the first time point of the plurality of time points over which the V′ (tₙ) values are summed, and t_{final-1} is the final time point of the plurality of time points over which the V′ (tₙ) values are summed.

It may be particularly beneficial for the combination to be, or to be based on, a sum of the values indicative of the intensity of the light emission at each of the plurality of time points. Advantageously, summing each of the values indicative of the intensity of the light emission at each of the plurality of time points may require relatively little computing power compared to other combinations without sacrificing much, if any, of the accuracy and reliability of the identification of the spectroscopic signature of the taggant.

Providing the intensity score may comprise comparing the intensity combination with stored data. Depending on a result of the comparison of the combination with the stored data, a function of the aerosol-generating device may be enabled or disabled.

The stored data may comprise data relating to an average or expected intensity combination for one or more particular taggants.

The stored data may comprise statistical dispersion data, for example statistical dispersion data for intensity combinations for one or more taggants. The stored data may comprise data indicating a likelihood of an intensity combination varying from an average or expected intensity combination for one or more particular taggants. For example, the stored data may comprise data indicating a standard deviation of an average or expected intensity combination for one or more particular taggants.

The intensity score may be greater the closer the intensity combination is to the average or expected intensity combination for one or more particular taggants. The intensity score may be used to determine one or more characteristics of the aerosol-generating article. The intensity combination being far from the average or expected intensity combination may result in a low intensity score and may indicate that the article is likely not an optimised article. The intensity combination being far from the average or expected intensity combination may result in a low intensity score and may indicate that the article is likely a non-optimised article. If the intensity combination is too far from the average or expected intensity combination, a function of the aerosol-generating device may be enabled or disabled. If the intensity score is less than an intensity score threshold, a function of the aerosol-generating device may be enabled or disabled. For example, an alarm function of the device may be enabled to alert the user that an article that is not an optimised article has been detected. For example, an alarm function of the device may be enabled to alert the user that a non-optimised article has been detected. As another example, the heater of the system may be disabled.

The intensity combination may be compared with a minimum expected intensity combination. The minimum expected intensity combination may be based on the stored data, for example the statistical dispersion data. If the intensity combination is less than the minimum expected intensity combination, this may indicate that the article is a non-optimised article. If the intensity combination is less than the minimum expected intensity combination, a function of the aerosol-generating device may be enabled or disabled. For example, an alarm function of the device may be enabled to alert the user that a non-optimised article has been detected. As another example, the heater of the system may be disabled.

The intensity combination may be compared with a maximum expected intensity combination. The maximum expected intensity combination may be based on the stored data, for example the statistical dispersion data. If the intensity combination is greater than the maximum expected intensity combination, this may indicate that the article is a non-optimised article. If the intensity combination is less than the maximum expected intensity combination, a function of the aerosol-generating device may be enabled or disabled. For example, an alarm function of the device may be enabled to alert the user that a non-optimised article has been detected. As another example, the heater of the system may be disabled.

The stored data may be comprise, or be in the form of, one or more look-up tables. Where the stored data comprises, or is in the form of, a look-up table, the look up table may comprise an intensity score for each of a number of intensity combinations, or for each of a number of ranges of intensity combinations, for example spanning between the minimum expected intensity combination and the maximum expected intensity combination. This look-up table may then be used as discussed above. That is, the determined intensity combination may be compared with the look-up table. If the determined intensity combination is less than the minimum expected intensity combination, or greater than the maximum expected intensity combination, then the determined intensity combination may not receive an intensity score. The article may instead be rejected. Otherwise, the determined intensity combination may be assigned an intensity score based on the intensity scores in the look-up table. For example, the determined intensity combination may be assigned an intensity score based on the intensity score for the intensity combination in the look-up table which the determined intensity combination is closest to, or for the range of intensity combinations in the look-up table within which the determined intensity combination falls.

As would be understood by the skilled person after reading this disclosure, the above passage relating to intensity combinations and intensity scores may be applicable to any combination and associated score. For example, the above passage may be applicable to any one or more of an intensity time derivative combination and associated score, such as an intensity time first derivative combination and associated score, an intensity time second derivative combination and associated score, or an intensity time greater than second derivative combination and associated score, a partial intensity combination and score, and a partial intensity time derivative combination and associated score.

The method, for example the step of analysing the light emission received by the light receiver, may comprise determining a value indicative of a time derivative of intensity of the light emission at each of a plurality of time points.

For example, the method, or the step of analysing the light emission received by the light receiver, may comprise determining a value indicative of a time first derivative of intensity of the light emission at each of a plurality of time points. Alternatively, or in addition, the method, or the step of analysing the light emission received by the light receiver, may comprise determining a value indicative of a time second derivative of intensity of the light emission at each of a plurality of time points. Alternatively, or in addition, the method, or the step of analysing the light emission received by the light receiver, may comprise determining a value indicative of a time greater than second derivative of intensity of the light emission at each of a plurality of time points.

The value indicative of a time derivative of intensity of the light emission at each of the plurality of time points may be calculated or otherwise determined based on the recorded values indicative of the intensity of the light emission at each of the plurality of time points. For example a value indicative of a time first derivative of intensity of the light emission at a particular time point may be calculated as: [a difference between the value indicative of the time first derivative of intensity of the light emission at the particular time point and the value indicative of the time first derivative of intensity of the light emission at the subsequent time point] divided by [a time difference between the particular time point and the subsequent time point]. In other words, the time first derivative of intensity may be calculated as a change in intensity over a corresponding change in time. As would be understood by the skilled person after reading this disclosure, there are various ways to calculate the values indicative of a time derivative of intensity of the light emission at each of a plurality of time points based on the recorded values indicative of the intensity of the light emission at each of the plurality of time points.

The plurality of time points may comprise at least 10, 20, 50, 100, 200, 500, or 1,000 time points. Advantageously, a greater number of time points may increase an accuracy and reliability of identifying the spectroscopic signature of the taggant.

The time points may occur at regular time intervals. The time points may occur at time intervals, for example regular time intervals, of at least 1, 2, 5, 10, 20, or 50 microseconds. The time points may occur at time intervals, for example regular time intervals, of no more than 100, 50, 20, 10, 5, or 2 microseconds. The time points may occur at time intervals, for example regular time intervals, of between 1 and 100 microseconds. Advantageously, such time intervals may adequately capture the time response of the light emission without requiring determination of an unnecessarily large number of values.

The time period over which the plurality of time points occur may be no more than 2,000, 1,000, 500, 200, 100, 50, 20, 10, 5, 2, 1, 0.9, or 0.5 milliseconds. Advantageously, such a time period may allow the system to adequately capture the time response of the light emission without requiring determination of an unnecessarily large number of values.

The method, for example the step of analysing the light emission received by the light receiver, may comprise calculating or otherwise providing a combination of the values indicative of the time derivative of intensity of the light emission at each of the plurality of time points. The combination of the values indicative of the time derivative of intensity of the light emission at each of the plurality of time points may be referred to as an intensity time derivative combination. And the combination of the values indicative of the time nth derivative of intensity of the light emission at each of the plurality of time points may be referred to as an intensity nth time derivative combination.

Thus, the method may comprise calculating or otherwise providing an intensity time first derivative combination. Alternatively, or in addition, the method may comprise calculating or otherwise providing an intensity time second derivative combination. Alternatively, or in addition, the method may comprise calculating or otherwise providing an intensity time greater than second derivative combination.

The method, for example the step of analysing the light emission received by the light receiver, may comprise calculating or otherwise providing an intensity nth time derivative score, for example based on the intensity nth time derivative combination. For example, analysing the light emission received by the light receiver may comprise calculating or otherwise providing any one, two, or more of an intensity first time derivative score, an intensity second time derivative score, and an intensity greater than second time derivative score. Any intensity time derivative score may be obtained by comparing the respective intensity time derivative combination with stored data, as explained in more detail below.

Advantageously, the use of such intensity time derivative scores may provide an accurate and reliable indication of the spectroscopic signature of the taggant.

Any of the intensity time derivative combinations, for example any one or more of the intensity time first derivative combination, intensity time second derivative combination and the intensity time greater than second derivative combination, may be based on a summation, multiplication, integral, or other function, of the values indicative of the respective time derivative of intensity of the light emission at each of the plurality of time points.

For example, an nth intensity time derivative combination may be calculated by summing each of the values indicative of the nth time derivative of intensity of the light emission at each of the plurality of time points. It may be particularly beneficial for any intensity time derivative combination to be, or to be based on, a sum of the values indicative of the respective time derivative of intensity of the light emission at each of the plurality of time points. Advantageously, summing each of the values indicative of the respective time derivative of intensity of the light emission at each of the plurality of time points may require relatively little computing power compared to other combinations without sacrificing much, if any, of the accuracy and reliability of the identification of the spectroscopic signature of the taggant.

Providing an intensity time derivative score, for example any one or more of the first intensity time derivative score, the second intensity time derivative score, and the third intensity time derivative score, may comprise comparing the intensity time derivative combination, which may be based on a summation, multiplication, integral, or other function, with stored data. The intensity time derivative score may be used to determine one or more characteristics of the aerosol-generating article. Depending on a result of the comparison of the intensity time derivative combination with the stored data, a function of the aerosol-generating device may be enabled or disabled.

The stored data may comprise data relating to an average or expected intensity time derivative combination for one or more particular taggants.

The stored data may comprise statistical dispersion data, for example statistical dispersion data for intensity time derivative combinations for one or more taggants. The stored data may comprise data indicating a likelihood of an intensity time derivative combination varying from an average or expected intensity time derivative combination for one or more particular taggants. For example, the stored data may comprise data indicating a standard deviation of an average or expected intensity time derivative combination for one or more particular taggants.

The intensity time derivative score may be greater the closer the intensity time derivative combination is to the average or expected intensity time derivative combination for one or more particular taggants. The intensity time derivative combination being far from the average or expected intensity time derivative combination may result in a low intensity time derivative score and may indicate that the article is likely a non-optimised article, and the article may be rejected. If the intensity time derivative combination is too far from the average or expected intensity time derivative combination, a function of the aerosol-generating device may be enabled or disabled. If the intensity time derivative score is less than an intensity time derivative score threshold, a function of the aerosol-generating device may be enabled or disabled. For example, an alarm function of the device may be enabled to alert the user that a non-optimised article has been detected. As another example, the heater of the system may be disabled.

The intensity nth time derivative combination may be compared with a minimum expected intensity nth time derivative combination. The minimum expected intensity nth time derivative combination may be based on the stored data, for example the statistical dispersion data. If the intensity nth time derivative combination is less than the minimum expected intensity nth time derivative combination, this may indicate that the article is a non-optimised article, and the article may be rejected. If the intensity nth time derivative combination is less than the minimum expected intensity nth time derivative combination, a function of the aerosol-generating device may be enabled or disabled. For example, an alarm function of the device may be enabled to alert the user that a non-optimised article has been detected. As another example, the heater of the system may be disabled.

The intensity nth time derivative combination may be compared with a maximum expected intensity nth time derivative combination. The maximum expected intensity nth time derivative combination may be based on the stored data, for example the statistical dispersion data. If the intensity nth time derivative combination is greater than the maximum expected intensity nth time derivative combination, this may indicate that the article is a non-optimised article, and the article may be rejected. If the intensity time derivative combination is less than the maximum expected intensity nth time derivative combination, a function of the aerosol-generating device may be enabled or disabled. For example, an alarm function of the device may be enabled to alert the user that a non-optimised article has been detected. As another example, the heater of the system may be disabled.

The stored data may be comprise, or be in the form of, one or more look-up tables. Where the stored data comprises, or is in the form of, a look-up table, the look up table may comprise an intensity time derivative score for each of a number of intensity time derivative combinations, or for each of a number of ranges of intensity time derivative combinations, for example spanning between the minimum expected intensity time derivative combination and the maximum expected intensity time derivative combination. This look-up table may then be used as discussed above. That is, the determined intensity time derivative combination may be compared with the look-up table. If the determined intensity time derivative combination is less than the minimum expected intensity time derivative combination, or greater than the maximum expected time derivative intensity combination, then the determined intensity time derivative combination may not receive an intensity time derivative score. The article may instead be rejected. Otherwise, the determined intensity time derivative combination may be assigned an intensity time derivative score based on the intensity time derivative scores in the look-up table. For example, the determined intensity time derivative combination may be assigned an intensity time derivative score based on the intensity time derivative score for the intensity time derivative combination in the look-up table which the determined intensity time derivative combination is closest to, or for the range of intensity time derivative combinations in the look-up table within which the determined intensity time derivative combination falls.

As would be understood by the skilled person after reading this disclosure, where the above paragraphs describe features relating generally to a time derivative or nth time derivative without specifying the time derivative (for example, whether the time derivative is the time first derivative), the features may be applicable to any one, two, or more or all of the time first derivative, the time second derivative, and the time greater than second derivative.

The method, for example the step of analysing the light emission received by the light receiver, may comprise determining a value indicative of an intensity of the light emission at at least one characteristic time point.

The method, for example the step of analysing the light emission received by the light receiver, may comprise determining a value indicative of a time derivative of intensity of the light emission at at least one characteristic time point.

The method, for example the step of analysing the light emission received by the light receiver, may comprise determining a value indicative of a time first derivative of intensity of the light emission at at least one characteristic time point.

The method, for example the step of analysing the light emission received by the light receiver, may comprise determining a value indicative of a time second derivative of intensity of the light emission at at least one characteristic time point.

The method, for example the step of analysing the light emission received by the light receiver, may comprise determining a value indicative of a time greater than second derivative of intensity of the light emission at at least one characteristic time point.

The or each characteristic time point may occur a predetermined length of time after the light source has ended illuminating the aerosol-generating article.

A characteristic time point may be selected based on an expected intensity, or intensity time derivative, at the characteristic time point. The intensity, or intensity time derivative, at the characteristic time point may be relatively stable between different articles comprising the same taggant. For example, the intensity, or intensity time derivative, at the characteristic time point may be relatively stable between different articles in the sense that, over 80% of articles comprising the same taggant in the same concentration, when exposed to the same illumination of light from the light source, emit a light emission having an intensity, or intensity time derivative, at the characteristic time point within 50, 30, 20, 10, or 5% of a particular value.

For example, if a first time derivative of intensity of the light emission from a particular taggant is found to be particularly stable, for example extremely similar regardless of the power of the light source or the concentration of the taggant etc., at a particular time after ending illuminating the article comprising the taggant, then that particular time after ending illuminating the article may be chosen as a characteristic time point. Then, by determining the first time derivative at that characteristic time point, it may be possible to reliably determine whether that taggant is present in the article, and thus whether the article is an optimised article. This is equally applicable to characteristics other than the first time derivative of intensity of the light emission.

A determined value indicative of the intensity, or a time derivative of intensity, of the light emission at a particular characteristic time point may be compared with stored data.

The stored data may comprise data relating to an average or expected value indicative of the intensity, or time derivative of intensity, of the light emission at the particular characteristic time point for one or more taggants. The stored data may comprise statistical dispersion data. The stored data may comprise data indicating a likelihood of the determined value varying from an average or expected value for one or more particular taggants. For example, the stored data may comprise data indicating a standard deviation of the determined value for one or more particular taggants. The stored data may comprise a look-up table.

A score may be assigned to the determined value, for example based on how close the determined value is to the average or expected value. The score may be used to determine one or more characteristics of the aerosol-generating article.

Depending on a result of the comparison of the determined value with the stored data, a function of the aerosol-generating device may be enabled or disabled. Depending on the score assigned to the determined value, a function of the aerosol-generating device may be enabled or disabled.

The determined value may be compared with a minimum expected determined value. The minimum expected determined value may be based on the stored data, for example the statistical dispersion data. If the determined value is less than the minimum expected determined value, this may indicate that the article is a non-optimised article, and the article may be rejected. If the determined value is less than the minimum expected determined value, a function of the aerosol-generating device may be enabled or disabled. For example, an alarm function of the device may be enabled to alert the user that a non-optimised article has been detected. As another example, the heater of the system may be disabled.

The determined value may be compared with a maximum expected determined value. The maximum expected determined value may be based on the stored data, for example the statistical dispersion data. If the determined value is greater than the maximum expected determined value, this may indicate that the article is a non-optimised article, and the article may be rejected. If the determined value is greater than the maximum expected determined value, a function of the aerosol-generating device may be enabled or disabled. For example, an alarm function of the device may be enabled to alert the user that a non-optimised article has been detected. As another example, the heater of the system may be disabled.

The stored data may be comprise, or be in the form of, one or more look-up tables. Where the stored data comprises, or is in the form of, a look-up table, the look up table may comprise a score for each of a number of determined values at each characteristic time point, or for each of a number of ranges of determined values at each characteristic time point, for example spanning between the minimum expected determined value and the maximum expected determined value. This look-up table may then be used as discussed above. That is, the determined value may be compared with the look-up table. If the determined value is less than the minimum expected determined value, or greater than the maximum expected determined value, then the determined value may not receive a score. The article may instead be rejected. Otherwise, the determined value may be assigned a score based on the scores in the look-up table. For example, the determined value may be assigned a score based on the score for the determined value in the look-up table which the determined value is closest to, or for the range of determined values in the look-up table within which the determined value falls. The method may comprise calculating or otherwise providing one or more partial intensity combinations. A partial intensity combination may be calculated or otherwise provided based on only a portion of the time response of the taggant.

Each partial intensity combination may be based on a different time period to the other partial intensity combinations. The time periods may be entirely separate or overlapping.

The method may comprise calculating or otherwise providing a first partial intensity combination and a second partial intensity combination. The first partial intensity combination may be based on a combination of values indicative of the intensity of the light emission at each of a plurality of time points, for example at each of a plurality of time points before a particular time. The particular time may be a predetermined time after the light source ends illuminating the article. The second partial intensity combination may be based on a combination of values indicative of the intensity of the light emission at each of a plurality of time points, for example at each of a plurality of time points after the particular time. The first partial intensity combination may be based on a different time period to the second partial intensity combination. The first partial intensity combination may be based on an earlier portion of a time response of the taggant than the second partial intensity combination.

The method, for example the step of analysing the light emission received by the light receiver, may comprise calculating or otherwise providing a partial intensity score for each of the partial intensity combinations.

As would be understood by the skilled person after reading this disclosure, features described above in relation to the intensity combination may be applicable to each of the plurality of partial intensity combinations, for example to one or both of the first and second partial intensity combinations. And features described above in relation to the intensity score may be applicable to each of the partial intensity scores, for example to one or both of the first and second partial intensity scores.

Thus, similarly to the intensity combination, each partial intensity score may be compared with stored data, and this comparison may be used to provide a partial intensity score. Each partial intensity score may be used in the same manner as the intensity score. Each partial intensity combination may be based on a summation, multiplication, integral, or other function, of the values indicative of the intensity of the light emission at each of the plurality of time points. Depending on a result of the comparison of the or each partial intensity combination with the stored data, a function of the aerosol-generating device may be enabled or disabled. The stored data may comprise data relating to an average or expected partial intensity combination for one or more particular taggants.

Advantageously, the use of partial intensity combinations may improve the accuracy and reliability of determining one or more characteristics of the aerosol-generating article.

The method may comprise calculating or otherwise providing a plurality of partial intensity time derivative combinations. A partial intensity time derivative combination may be calculated or otherwise provided based on only a portion of the time response of the taggant.

Each partial intensity time derivative combination may be based on a different time period to the other partial intensity time derivative combinations. The time periods may be entirely separate or overlapping.

The method may comprise calculating or otherwise providing a first partial intensity time derivative combination and a second partial intensity time derivative combination. Each partial intensity time derivative combinations may be one of a partial intensity time first, second, or greater than second derivative combinations. The partial intensity time derivative combinations may or may not relate to the same time derivative. For example, the method may comprise calculating or otherwise providing zero, one or more partial intensity time first derivative combinations, zero, one or more partial intensity time second derivative combinations, zero, one or more partial intensity time greater than second derivative combinations.

The first partial intensity time derivative combination may be based on a different time period to the second partial intensity time derivative combination. For example, where the first partial intensity time derivative combination and the second partial intensity time derivative combination relate to the same time derivative, for example to a time first, second or greater than second time derivative, the first partial intensity time derivative combination may be based on a different time period to the second partial intensity time derivative combination. The first partial intensity time derivative combination may be based on a combination of values indicative of a time derivative of intensity of the light emission at each of a plurality of time points before a particular time. The second partial intensity time derivative combination may be based on a combination of values indicative of the time derivative of intensity of the light emission at each of a plurality of time points after the particular time. The first partial intensity time derivative combination may be based on an earlier portion of a time response of the taggant than the second partial intensity time derivative combination.

The method, for example the step of analysing the light emission received by the light receiver, may comprise calculating or otherwise providing a partial intensity time derivative score for each of the partial intensity time derivative combinations.

As would be understood by the skilled person after reading this disclosure, features described above in relation to the intensity time derivative combination may be applicable to each of the plurality of partial intensity time derivative combinations, for example to one or both of the first and second partial intensity time derivative combinations. And features described above in relation to the intensity time derivative score may be applicable to each of the partial intensity time derivative scores, for example to one or both of the first and second partial intensity time derivative scores.

Thus, similarly to the intensity time derivative combination, each partial intensity time derivative score may be compared with stored data, and this comparison may be used to provide a partial intensity time derivative score. Each partial intensity time derivative score may be used in the same manner as the intensity time derivative score. Each partial intensity time derivative combination may be based on a summation, multiplication, integral, or other function, of the values indicative of the time derivative of intensity of the light emission at each of the plurality of time points. Depending on a result of the comparison of the or each partial intensity time derivative combination with the stored data, a function of the aerosol-generating device may be enabled or disabled. The stored data may comprise data relating to an average or expected partial intensity time derivative combination for one or more particular taggants.

Advantageously, the use of partial intensity time derivative combinations may improve the accuracy and reliability of determining one or more characteristics of the aerosol-generating article.

As discussed above, the method may comprise calculating or otherwise providing one or more combinations. For example, the method may comprise providing an intensity combination and may comprise providing one or more intensity time derivative combinations. The method may also comprise comparing one or more combinations with with one or more other combinations or with stored data, for example to provide one or more scores. For example, the method may comprise one or both of: comparing the intensity combination with stored data to provide an intensity score; and comparing the intensity nth time derivative combination with stored data to provide an intensity nth time derivative score. The method may also comprise determining one or more values at at least one characteristic time point. One or more of the values may be indicative of intensity of the light emission at at least one characteristic time point. One or more of the values may be indicative of a time derivative of intensity, for example one or more of a first, second and greater than second time derivative of intensity, of the light emission at at least one characteristic time point. One or more of the values may be compared with stored data, for example to provide one or more scores.

The method may comprise comparing each of a plurality of scores, for example any of the scores discussed above, with a respective score threshold, for example a respective score threshold based on the stored data. The method may comprise combining multiple scores, for example any scores discussed above, to form a combined score. The method may comprise comparing the combined score with a combined score threshold, for example a combined score threshold based on the stored data. The method may comprise combining multiple scores to form multiple combined scores. The method may comprise comparing the combined scores with respective combined score thresholds, for example combined score thresholds based on the stored data.

Where a plurality of scores are provided, a function of the device may be enabled or disabled, or one or more characteristics of the aerosol-generating article may be determined, only if at least one, two, three, more or each of the scores are greater than their respective score thresholds. For example, a function of the device may be enabled or disabled only if the intensity score is greater than the intensity score threshold and the intensity first time derivative score is greater than the intensity first time derivative score threshold. As a second example, a function of the device may be enabled or disabled only if the intensity score is greater than the intensity score threshold and the intensity second time derivative score is greater than the intensity second time derivative score threshold. As a third example, a function of the device may be enabled or disabled only if the intensity first time derivative score is greater than the intensity first time derivative score threshold and the intensity second time derivative score is greater than the intensity second time derivative score threshold. As a fourth example, a function of the device may be enabled or disabled only if the intensity score is greater than the intensity score threshold, the intensity first time derivative score is greater than the intensity first time derivative score threshold, and the intensity second time derivative score is greater than the intensity second time derivative score threshold. As a fifth example, the device may determine an intensity score, an intensity time first derivative score and an intensity time second derivative score, and a function of the device may be enabled or disabled if any two of these three scores are greater than their respective score thresholds. Any number of scores, and any particular scores, that need to be greater than their respective thresholds in order to determine a characteristic of the article or enable or disable a function of the device, may be selected.

Alternatively, or in addition, where a plurality of scores are provided, the method may comprise combining two or more or each of the scores to provide a combined score. The combined score may be a sum score, for example where the plurality of scores have been summed. The combined score may then be compared with a combined score threshold. The combined score may be used to determine one or more characteristics of the aerosol-generating article. Determining that the combined score is greater than the combined score threshold may be used to determine one or more characteristics of the aerosol-generating article. A function of the device may be enabled or disabled only if the combined score is greater than the combined sum score threshold.

Prior to combining the plurality of scores, each score may be assigned a multiplier. The multiplier may be thought of as a weighting, and may be used if one of the scores is considered to be more important than another. Each score may be multiplied by its respective multiplier to determine a plurality of weighted scores. The weighted scores may then be combined, for example summed, to provide a weighted combined score, for example a weighted sum score. The weighted combined score may then be compared with a weighted combined score threshold. The weighted combined score may be used to determine one or more characteristics of the aerosol-generating article. Determining that the weighted combined score is greater than the weighted combined score threshold may be used to determine one or more characteristics of the aerosol-generating article. A function of the device may be enabled or disabled only if the weighted combined score is greater than the weighted combined score threshold.

Thus, in summary, as would be understood by the skilled person after reading this disclosure, the method may comprise analysing any one, two, three, more or all of the following characteristics:
an intensity of the light emission over time;
a time first derivative of intensity of the light emission over time;
a second time derivative of intensity of the light emission over time;
a time greater than second derivative of intensity of the light emission over time; and
one or both of an intensity, or a time derivative of intensity, for example one or more of a first, second and greater than second time derivative of intensity, of the light emission at at least one characteristic time point.

The method may comprise calculating or otherwise determining a value indicative of any of the first four characteristics listed immediately above at each of a plurality of time points. The method may comprise calculating, or otherwise determining, one or more combinations, each combination being a combination of the values of one of the first four characteristics listed above at each of a plurality of time points. The combination may be, or may be based on, a sum of the values of one of the first four characteristics listed above at each of a plurality of time points. The method may comprise calculating, or otherwise determining, one or more partial combinations for any one or more of the values of one of the first four characteristics listed above at each of a plurality of time points.

The method may comprise comparing any one or more or each determined combination, or determined partial combination, with stored data such as stored data comprising statistical dispersion data relating to the combination or partial combination. If any determined combination, or determined partial combination, falls below a minimum expected combination or above a maximum expected combination, the article may be identified as not an optimised article. Any one or more or each comparison may be used to provide a score. The score may be greater the closer the determined combination is to an expected or average combination, for example an expected or average combination according to the stored data.

The method may comprise calculating or otherwise determining one or more values indicative of intensity, or a time derivative of intensity, of the light emission at at least one characteristic time point.

The method may comprise comparing one or more of the values indicative of intensity, or a time derivative of intensity, at at least one characteristic time point with stored data such as stored data comprising statistical dispersion data relating to the values indicative of intensity, or a time derivative of intensity, at the at least one characteristic time point. If any value is below a minimum expected value or above a maximum expected value, the article may be rejected. Any one or more or each value may be used to provide a score.

The method may comprise comparing any one or more or each score with a respective score threshold. If a predetermined number, for example one, of the scores is lower than its score threshold, the article may be rejected. The score may be greater the closer the determined value is to an expected or average value, for example an expected or average value according to the stored data.

Each score may be compared with a respective score threshold, for example a score threshold of the stored data. If a score is less than its score threshold, the article may be rejected. If a predetermined number of the scores are less than their respective score thresholds, the article may be rejected.

The method may comprise combining any two or more scores to provide a combined score. The method may comprise combining scores to provide multiple combined scores. For example, the method may comprise combining two or more scores to provide a first combined score, and two or more different, or overlapping, scores to provide a second combined score. Combining the scores may be or comprise summing the scores, for example to provide a sum score.

The combined score may be compared with a respective combined score threshold, for example a combined score threshold of the stored data. If the combined score is less than the combined score threshold, the article may be rejected.

Where there are multiple combined scores, if a predetermined number of the combined scores are less than their respective combined score thresholds, the article may be rejected.

The light source may comprise a light emitting diode. The light source may be a source of infrared light. The light source may comprise an infrared light emitting diode. Illuminating the article may comprise illuminating the article with infrared light.

The light receive may comprise a photodiode.

The step of the light source illuminating the aerosol-generating article engaged with the aerosol-generating device may be or comprise the light source illuminating the aerosol-generating article engaged with the aerosol-generating device for a predetermined amount of time.

The article may comprise at least one component incorporating the taggant within a material of the at least one component. The use of the taggant incorporated within the material of a component of the article may advantageously prevent the taggant from being removed from the component after manufacture. In this way, the tamper resistance of the article, and the difficulty of using non-optimised articles with the aerosol-generating device may be improved.

The taggant may be incorporated into any component of the aerosol-generating article, including but not limited to: paper, such as wrapper paper; filters; tipping papers; tobacco; tobacco wraps; coatings; binders; fixations; glues; inks, foams, hollow acetate tubes; wraps; and lacquers. The taggant may be incorporated into the component by either adding it during the manufacture of the material, for example by adding it to a paper slurry or paste before drying, or by painting or spraying it onto the component. Typically, the taggant is incorporated into the component in trace, nano-gram, quantities. For example, where the taggant is sprayed on the surface, the solution being sprayed may incorporate the taggant in a concentration of between 1 ppm and 1000 ppm.

The taggant may comprise an identifiable spectroscopic signature in emission. When the taggant is illuminated by the light source, the light preferably excites the taggant and the taggant preferably emits at least one wavelength of light shifted from the wavelength of the illuminating light. This may be a form of photoluminescence, and may be phosphorescence. By controlling the physical and chemical structure of the taggant the spectroscopic signature can be controlled.

In a preferred embodiment, the wavelength of the light emitted by the taggant is not in the visible spectrum. Preferably, the wavelength(s) of the light emitted by the taggant is or are in one or both of the infrared and ultraviolet range.

In a preferred embodiment, the taggant is distributed throughout the material. By distributing the taggant throughout the material, the orientation of the aerosol-generating article within the aerosol-generating device may not be important. This enables the use of the system to be simpler for the user. In addition, by distributing the taggant throughout the material, the tamper resistance of the article may be improved because it may be more difficult to completely remove the taggant. In a particularly preferred embodiment, the taggant is substantially homogeneously distributed throughout the material.

Different articles may comprise different taggants, or different combinations of taggants. These taggants or combinations of taggants may have different and identifiable spectroscopic signatures. This may allow the device to distinguish between different types of articles and operate accordingly.

The taggant is preferably stable at elevated temperatures of at least 500, 1,000 or 1,500 degrees Celsius. As used herein, the term stable may refer to the taggant having a consistent spectroscopic signature, and to the taggant not decomposing. By providing a taggant which remains stable at elevated temperatures, standard manufacturing processes may be used when manufacturing the aerosol-generating article.

The material of the aerosol-generating component incorporating the taggant may be manufactured by adding the taggant as an ingredient in the slurries used to make the material. The slurries may then be formed, for example by casting, and dried to produce the material, such as paper or wrapper material.

The taggant may be configured such that at normal operating temperature of the aerosol-generating article the taggant is deactivated. As used herein, deactivated may refer to the taggant no longer having the identifiable spectroscopic signature. In use, the temperature required to generate an aerosol may be greater than the temperature required to deactivate the taggant. In this way, the aerosol-generating device can determine whether the aerosol-generating article has been used previously, and operate accordingly. The temperature range of the aerosol-generating article components during normal operation is preferably between about 50 degrees Celsius and about 300 degrees Celsius depending on the location and type of component of the aerosol-generating device. As such, preferably the taggant is deactivated at a temperature between about 50 degrees Celsius and about 500 degrees Celsius. More preferably, the taggant is deactivated at a temperature between about 70 degrees Celsius and about 100 degrees Celsius.

The taggant may be deactivated by decomposing at the above elevated temperatures such that it no longer has the identifiable spectroscopic signature. Alternatively, the taggant may be deactivated by being masked by an additional, temperature-dependent additive. The additional additive may become opaque at the elevated temperature, or may change colour to mask the taggant's signature.

Similarly to the above description of the taggant being stable at elevated temperatures, the taggant is preferably chemically stable. Preferably, the taggant is sufficiently chemically stable so as not to decompose during manufacture of the material or the component. Thus, the taggant is preferably stable when it is: exposed to liquid water; exposed to water vapour; exposed to other commonly used solvents; upon drying; upon physical deformation of the material to form the component; upon exposure to increased temperatures; and upon exposure to reduced temperatures. As such, during the above described material manufacturing process, the taggant does not decompose and the taggant maintains the identifiable spectroscopic signature.

The taggant is preferably in powder form. Taggant powder advantageously enables the taggant to be incorporated into the material more easily. Preferably, the taggant is a powder composed of at least one of: a rare earth; an actinide metal oxide; a ceramic. The rare earth is preferably a lanthanide.

The identifiable spectroscopic signature of the taggant may be associated with one or more of the aerosol-generating article type, the aerosol-forming substrate type, the date of production, the place of production, the batch number, other production details, and the use-by-date.

As would be understood by the skilled person after reading this disclosure, an aim of the step of analysing the light emission received by the light receiver may be to determine whether the light emission is from, or likely to be from, a particular taggant or type of taggant. This may allow identification of the taggant or type of taggant, and thus allow identification of one or more characteristics of the aerosol-generating article. The inventors have found that particular analyses of the light emission may be both reliable and computationally efficient. Some possible steps of such analyses are set out below. The skilled person would, after reading this disclosure, have no difficulty implementing such analyses in an embodiment which aims to identify a taggant to an acceptable level of certainty.

Analysing the light emission received by the light receiver may comprise determining or estimating at least one trait of the light emission. Analysing the light emission received by the light receiver may comprise determining or estimating at least one trait of the light emission at each of n time points. That is, analysing the light emission received by the light receiver may comprise determining or estimating at least a first trait of the light emission at a first time, at least a second trait at a second time . . . and at least an nth trait at an nth time. It may be particularly preferable for n to be at least 2. However, n may be greater than 2, 5, 10, 20, 50, or 100. The n time points may be after ending illuminating the aerosol-generating article. Thus, the determined or estimated traits may suitably characterise the decay of the light emission from the aeroso-generating article. A particular trait of the light emission at a particular time may be one of, or be a function of one or more of, an intensity of the light emission at that time, a time first derivative of intensity of the light emission at that time, a time second derivative of intensity of the light emission at that time, and a time greater than second derivative of intensity of the light emission at that time. Thus, an example of a trait at time T1 may be the intensity of the light emission at time T1. A second example may be the square of the first time derivative of intensity of the light emission at time T1.

Analysing the light emission received by the light receiver may comprise one or both of: comparing a trait (the trait being a trait of the light emission determined or estimated at a particular time point, as discussed above) with a corresponding threshold, for example a predetermined threshold, and determining whether a trait falls within a corresponding range, for example predetermined range.

Analysing the light emission received by the light receiver may comprise one or both of: comparing a function of two or more traits with a corresponding threshold, for example a predetermined threshold, and determining whether a function of two or more of these traits falls within a corresponding range, for example predetermined ranges. Analysing the light emission received by the light receiver may comprise comparing a first function of two or more traits with a second function of two or more traits. The two or more traits involved in the first function may or may not overlap with the two or more traits involved in the second function. That is, one or more traits may be involved in both the first function and the second function.

The function of two or more traits may be a function of at least two traits of the same type corresponding to different time points. As an example, the type of trait may be a time first derivative of intensity of the light emission. Thus, the function of two or more traits may be a time first derivative of intensity of the light emission at time T1 multiplied by a time first derivative of intensity of the light emission at time T2. Alternatively, the function of two or more traits may be a function of two traits of different type. In this case, where the two traits are of different types, the two traits may be estimated or determined at the same time point or at different time points. As an example of how a comparison between the first function and the second function could be used to identify, or help identify a taggant, it may be known that, for a particular taggant, the intensity of the light emission decays very quickly immediately after ending illumination of the taggant. In this case, one could compare a first multiplication of the intensities of the light emission at first and second time points with a second multiplication of the intensities of the light emission at subsequent third and fourth time points. Then, if the first multiplication is at least, for example, double the second multiplication, this may indicate that the intensity of the light emission has decayed very quickly and may therefore indicate, or help to indicate, that the taggant is the particular taggant.

Analysing the light emission received by the light receiver may comprise determining or estimating a time taken for a trait of the light emission to increase or decrease from a first level to a second level. For example, a trait of the light emission may be determined at a first time to be a first level, X. This first time may be a predetermined time after the light source ending illuminating the aerosol-generating article. Then, a time taken for the trait to increase or decrease from the first level to a second level, Y, may be estimated or determined.

Analysing the light emission received by the light receiver may also comprise determining or estimating a time taken for the trait of the light emission to increase or decrease from the second level to a third level. Analysing the light emission received by the light receiver may also comprise determining or estimating a time taken for the trait of the light emission to increase or decrease from the third level to a fourth level, from the fourth level to a fifth level, and so on, until determining or estimating a time taken for the trait of the light emission to reduce from an (n−1)^{th} level to an nth level.

Generally, any given level may be a function of one or more preceding levels. For example, the third level may be a function of one or both of the second level and the first level, such as the second level plus or minus a predetermined value.

As would be understood by the skilled person after reading this disclosure, any one or more, or function of one or more, of the times taken described in the above few paragraphs may suitably characterise the light emission from the taggant. This may allow identification of the taggant or type of taggant. Thus, any one or more of the times taken may be used, alone or in combination with other factors, to determine a characteristic of the aerosol-generating article. For example, analysing the light emission may comprise determining whether any one or more of the times taken discussed in the above two paragraphs fall within one or more corresponding ranges, for example predetermined corresponding ranges. If a particular time taken falls within a corresponding range, or if, as a merely illustrative example, 6 out of 7 particular times taken fall within their corresponding ranges, this may allow identification of the taggant to a suitable degree of certainty.

Analysing the light emission received by the light receiver may comprise one or both of collecting and recording data based on the light emission. Analysing the light emission received by the light receiver may comprise comparing this data with predetermined reference data. The reference data may be stored in a memory, such as a memory of the aerosol-generating device.

The data may be, comprise, or be based on, the one or more traits of the light emission determined or estimated at each of the n time points, as discussed above. The reference data may be, comprise, or be based on, one or more corresponding expected traits of the light emission at each of the n time points.

An expected trait may refer to a trait expected to be obtained from the light emission of a particular taggant, for example in laboratory conditions. Expected traits may have originally been obtained from a light emission from a particular taggant, for example in laboratory conditions. The reference data may comprise multiple sets of reference data relating to different taggants. Thus, analysing the light emission received by the light receiver may comprise comparing the data with each of a plurality of sets of reference data, optionally wherein each of the plurality of sets of reference data relates to a different taggant. This may allow identification of which, if any, of a plurality of taggants are present in the aerosol-generating article.

A corresponding trait may refer to a trait of the same type. Thus, as an example, if a particular trait of the light emission determined or estimated is an intensity of the light emission, then the corresponding expected trait may be the expected intensity of the light emission. So at least a portion of the data may be based on an intensity of the light emission determined or estimated at each of n times, and this data may be compared with reference data based on an expected intensity of the light emission at each of the n times. Alternatively, or in addition, any one or more time derivatives of intensity of the light emission at n time points may be compared with any one or more corresponding, expected time derivatives of intensity of the light emission at n time points.

A trait determined or estimated at a particular time point may be compared with a corresponding, expected trait at a corresponding time point. As would be understood by the skilled person after reading this disclosure, there are multiple ways to determine which time point of the reference data corresponds to the time point of the data. As an illustrative example, the time at which the illumination of the aerosol-generating article ends may be aligned for the data and the reference data. Alternatively, or in addition, a first time point for both the data and the reference data may be aligned. Then, a corresponding time of the reference data may be an identical or most similar time after ending of the illumination of the aerosol-generating article, or after the first time point.

The comparison may be repeated for multiple time points. Thus, a trait determined or estimated at each of n time points may be compared with a corresponding, expected trait at each of n corresponding time points.

The comparison may be carried out for multiple traits. Thus, multiple traits determined or estimated at a time point may be compared with multiple corresponding, expected traits at a corresponding time point. Or multiple traits determined or estimated at each of n time points may be compared with multiple corresponding, expected traits at each of n corresponding time points.

Comparison between a determined or estimated trait of the data and a corresponding, expected trait of the reference data may comprise determining whether the determined or estimated trait falls within a range including the corresponding, expected trait, for example determining whether the estimated or determined trait falls within +/−10% of the corresponding, expected trait. Such a comparison may be repeated for multiple, or all, of the n time points. If a predetermined proportion of the estimated or determined traits fall within their corresponding expected ranges, this may allow identification of the taggant to a reasonable degree of certainty, and thus allow a characteristic of the aerosol-generating article to be determined.

Analysing the light emission received by the light receiver may comprise determining or estimating differences between determined or estimated traits at n time points and corresponding, expected traits at n corresponding time points. These differences, or a function of these differences such as a magnitude of these differences, may be compared with a threshold. This may allow identification of the taggant. For example, if a sum of the magnitudes of the differences between a determined or estimated trait at n time points and a corresponding, expected trait at n corresponding time points is less than a threshold, this may indicate that the taggant is a particular taggant to which the reference data relates to a reasonable degree of certainty.

According to the present disclosure, there is provided an aerosol-generating device. The device may be configured to engage with, and disengage from, an aerosol-generating article. The article may comprise a taggant. The taggant may have an identifiable spectroscopic signature. The taggant may be excitable by light, for example to emit a light emission. The device may comprise a light source for illuminating an aerosol-generating article engaged with the device. The device may comprise a light receiver for receiving light emitted by an aerosol-generating article engaged with the device. The device may comprise a controller. The controller may be configured to activate the light source to illuminate the aerosol-generating article engaged with the aerosol-generating device so as to excite the taggant to emit the light emission. The controller may be configured to deactivate the light source to end illuminating the aerosol-generating article engaged with the aerosol-generating device. The controller may be configured to analyse the light emission received by the light receiver after ending the light source illuminating the aerosol-generating article, for example to identify the spectroscopic signature of the taggant and optionally to determine a characteristic of the aerosol-generating article.

Thus, according to a second aspect of the present disclosure, there is provided an aerosol-generating device configured to engage with, and disengage from, an aerosol-generating article comprising a taggant having an identifiable spectroscopic signature, the taggant being excitable by light to emit a light emission. The aerosol-generating device comprises a light source for illuminating an aerosol-generating article engaged with the device; a light receiver for receiving light emitted by an aerosol-generating article engaged with the device; and a controller. The controller is configured to activate the light source to illuminate the aerosol-generating article engaged with the aerosol-generating device so as to excite the taggant to emit the light emission; deactivate the light source to end illuminating the aerosol-generating article engaged with the aerosol-generating device; and analyse the light emission received by the light receiver after the light source ending illuminating the aerosol-generating article to determine a characteristic of the aerosol-generating article.

The device or controller may configured to carry out any of the method steps described herein. The device or controller may configured to carry out a method according to the first aspect.

According to the present disclosure, there is provided a controller for an aerosol-generating device. The device may be configured to engage with, and disengage from, an aerosol-generating article. The article may comprise a taggant having an identifiable spectroscopic signature. The taggant may be excitable by light, for example to emit a light emission. The device may comprise a light source for illuminating an aerosol-generating article engaged with the device. The device may comprise a light receiver for receiving light emitted by an aerosol-generating article engaged with the device. The controller may be configured to activate the light source to illuminate the aerosol-generating article engaged with the aerosol-generating device so as to excite the taggant to emit the light emission. The controller may be configured to deactivate the light source to end illuminating the aerosol-generating article engaged with the aerosol-generating device. The controller may be configured to analyse the light emission received by the light receiver after the light source ending illuminating the aerosol-generating article, for example to identify the spectroscopic signature of the taggant and optionally to determine a characteristic of the aerosol-generating article.

According to a third aspect of the present disclosure, there is provided a controller for an aerosol-generating device. The device is configured to engage with, and disengage from, an aerosol-generating article. The article comprises a taggant having an identifiable spectroscopic signature. The taggant is excitable by light to emit a light emission. The device comprises a light source for illuminating an aerosol-generating article engaged with the device. The device comprises a light receiver for receiving light emitted by an aerosol-generating article engaged with the device. The controller is configured to activate the light source to illuminate the aerosol-generating article engaged with the aerosol-generating device so as to excite the taggant to emit the light emission. The controller is configured to deactivate the light source to end illuminating the aerosol-generating article engaged with the aerosol-generating device. The controller is configured to analyse the light emission received by the light receiver after the light source ending illuminating the aerosol-generating article to determine a characteristic of the aerosol-generating article.

The controller may configured to carry out any of the method steps described herein. The controller may configured to carry out a method according to the first aspect.

Features described in relation to one aspect of this disclosure may be applicable to any other aspect of this disclosure. Features described as steps of a method may be applicable to the device or controller described herein. The device or controller may be configured to carry out any of the method steps described herein.

As used herein, the term “rejecting an article” may refer to an action taken when a characteristic of the article is determined. For example, it may be determined that the article does not comprise a taggant, or does not comprise one of a number of specific taggants. This may indicate that the article is a non-optimised article. Such an article may be rejected. Rejecting an article may comprise enabling or disabling a function of the device. For example, the device may disable operation of a heater or heating element. As another example, the device may inform the user, for example with a visual, audible, or tactile alert, that the article is a non-optimised article.

As used herein, the term “accepting an article” may refer to an action taken when a characteristic of the article is determined. For example, it may be determined that the article does comprises a taggant, or comprises one or more of a number of specific taggants. This may indicate that the article is an optimised article. Such an article may be accepted. Accepting an article may comprise enabling or disabling a function of the device. For example, the device may enable operation of a heater or heating element. As another example, the device may inform the user, for example with a visual, audible, or tactile alert, that the article is an optimised article.

As used herein, the term “indicative of” may mean indicating, or related to. For example, if a first value is indicative of a second value, then the first value may be proportional to the second value.

Features described herein in relation to a time derivative, or to anything associated with a time derivative (for example an intensity time derivative combination, score or threshold score), without specifying the particular time derivative (for example, whether the time derivative is the time first derivative, or the time second derivative), may be applicable to any one, two, three or more particular time derivatives. For example, features described herein in relation to a time derivative, or to anything associated with a time derivative, without specifying the particular time derivative, may be applicable to any one or more of the first time derivative, the second time derivative, and a greater than second time derivative.

The invention is defined in the claims. However, below there is provided a non-exhaustive list of non-limiting examples. Any one or more of the features of these examples may be combined with any one or more features of another example, embodiment, or aspect described herein.

Example Ex1. A method of controlling an aerosol-generating system, the system comprising:
an aerosol-generating article comprising a taggant having an identifiable spectroscopic signature, the taggant being excitable by light to emit a light emission; and
an aerosol-generating device configured to engage with, and disengage from, the aerosol-generating article, the device comprising:
a light source for illuminating an aerosol-generating article engaged with the device; and
a light receiver for receiving light emitted by an aerosol-generating article engaged with the device,
the method comprising:

the light source illuminating the aerosol-generating article engaged with the aerosol-generating device so as to excite the taggant to emit the light emission;
the light source ending illuminating the aerosol-generating article engaged with the aerosol-generating device;
the light receiver receiving the light emission after the light source ending illuminating the aerosol-generating article; and
analysing the light emission received by the light receiver to determine a characteristic of the aerosol-generating article.

Example Ex2. A method according to example Ex1, wherein analysing the light emission received by the light receiver comprises analysing an intensity of the light emission over time.

Example Ex3. A method according to any preceding example, wherein analysing the light emission received by the light receiver comprises analysing at least one time derivative of intensity of the light emission over time, for example analysing:
a time first derivative of intensity of the light emission over time;
a time second derivative of intensity of the light emission over time;
a time greater than second derivative of intensity of the light emission over time;
both a time first derivative of intensity of the light emission over time and a time second derivative of intensity of the light emission over time;
both a time first derivative of intensity of the light emission over time and a time greater than second derivative of intensity of the light emission over time;
both a time second derivative of intensity of the light emission over time and a time greater than second derivative of intensity of the light emission over time; or
all of a time first derivative of intensity of the light emission over time, a time second derivative of intensity of the light emission over time, and a time greater than second derivative of intensity of the light emission over time.

Example Ex4. A method according to any preceding example, wherein analysing the light emission received by the light receiver comprises analysing both an intensity of the light emission over time and at least one time derivative of intensity of the light emission over time, for example analysing:
both an intensity of the light emission over time and a time first derivative of intensity of the light emission over time;
both an intensity of the light emission over time and a time second derivative of intensity of the light emission over time;
both an intensity of the light emission over time and a time greater than second derivative of intensity of the light emission over time; or
an intensity of the light emission over time, a time first derivative of intensity of the light emission over time, and a time second derivative of intensity of the light emission over time.

Example Ex5. A method according to any preceding example, wherein analysing the light emission received by the light receiver comprises converting the light emission received by the light receiver into an electrical signal indicative of an intensity of the light emission over time.

Example Ex6. A method according to any preceding example, wherein analysing the light emission received by the light receiver comprises determining a value indicative of an intensity of the light emission at each of a plurality of time points.

Example Ex7. A method according to example Ex6, wherein analysing the light emission received by the light receiver comprises calculating or otherwise providing a combination, for example a combination which is, or is based on, a summation, multiplication, integral, or other function, of the values indicative of the intensity of the light emission at each of the plurality of time points, and optionally comparing a combination of the values indicative of the intensity of the light emission at each of the plurality of time points with stored data, for example stored data comprising one or both of statistical dispersion data and an average or expected combination for one or more particular taggants.

Example Ex8. A method according to example Ex7, wherein comparing the combination of the values indicative of the intensity of the light emission at each of the plurality of time points with stored data comprises comparing the combination of the values indicative of the intensity of the light emission at each of the plurality of time points with a minimum expected combination, and optionally rejecting the article, for example enabling or disabling a function of the device, if the combination is less than the minimum expected combination.

Example Ex9. A method according to example Ex7 or Ex8, wherein comparing the combination of the values indicative of the intensity of the light emission at each of the plurality of time points with stored data comprises comparing the combination of the values indicative of the intensity of the light emission at each of the plurality of time points with a maximum expected combination, and optionally rejecting the article, for example enabling or disabling a function of the device, if the combination is greater than the maximum expected combination.

Example Ex10. A method according to any of examples Ex7 to Ex9, wherein comparing the combination of the values indicative of the intensity of the light emission at each of the plurality of time points with stored data is used to provide an intensity score.

Example Ex11. A method according to any of examples Ex10, wherein the intensity score is greater the closer the combination of the values indicative of the intensity of the light emission at each of the plurality of time points is to an average or expected combination of the values indicative of the intensity of the light emission at each of the plurality of time points according to the stored data.

Example Ex12. A method according to example Ex10 or Ex11, wherein the method comprises comparing the intensity score with a threshold intensity score, for example a threshold intensity score based on the stored data.

Example Ex13. A method according to example Ex12, wherein the method comprises rejecting the article, for example enabling or disabling a function of the device, depending on the result of the comparison of the intensity score with the threshold intensity score.

Example Ex14. A method according to any preceding example, wherein analysing the light emission received by the light receiver comprises determining a value indicative of a time derivative, for example a time first derivative, or a time second derivative, or a time greater than second derivative, of intensity of the light emission at each of a plurality of time points.

Example Ex15. A method according to claim Example Ex14, wherein analysing the light emission received by the light receiver comprises calculating or otherwise providing a combination of the values indicative of the time derivative of intensity of the light emission at each of the plurality of time points.

Example Ex16. A method according to claim Example Ex15, wherein analysing the light emission received by the light receiver comprises comparing the combination of the values indicative of the time derivative of intensity of the light emission at each of the plurality of time points with stored data, optionally wherein the combination is based on a summation, multiplication, integral, or other function of the values indicative of the time derivative of intensity of the light emission at each of the plurality of time points.

Example Ex17. A method according to example Ex16, wherein comparing the combination of the values indicative of the time derivative of intensity of the light emission at each of the plurality of time points with stored data comprises comparing the combination of the values indicative of the time derivative of intensity of the light emission at each of the plurality of time points with a minimum expected combination, and optionally rejecting the article, for example enabling or disabling a function of the device, if the combination is less than the minimum expected combination.

Example Ex18. A method according to example Ex16 or Ex17, wherein comparing the combination of the values indicative of the time derivative of intensity of the light emission at each of the plurality of time points with stored data comprises comparing the combination of the values indicative of the time derivative of intensity of the light emission at each of the plurality of time points with a maximum expected combination, and optionally rejecting the article, for example enabling or disabling a function of the device, if the combination is greater than the maximum expected combination.

Example Ex20. A method according to any of examples Ex16 to Ex18, wherein the method comprises comparing the combination of the values indicative of the time derivative of intensity of the light emission at each of the plurality of time points with stored data to provide an intensity time derivative score.

Example Ex21. A method according to example Ex20, wherein the intensity time derivative score is greater the closer the combination of the values indicative of the time derivative of intensity of the light emission at each of the plurality of time points is to an average or expected combination of the values indicative of the time derivative of intensity of the light emission at each of the plurality of time points according to the stored data.

Example Ex22. A method according to example Ex20 or Ex21, wherein the method comprises comparing the intensity time derivative score with a threshold intensity time derivative score, for example a threshold intensity time derivative score based on the stored data.

Example Ex23. A method according to example Ex22, wherein the method comprises rejecting the article, for example enabling or disabling a function of the device, depending on the result of the comparison of the intensity time derivative score with the threshold intensity time derivative score.

Example Ex24. A method according to any preceding example, wherein analysing the light emission received by the light receiver comprises:
determining a value indicative of an intensity of the light emission at each of a plurality of time points;
determining a value indicative of a time derivative of intensity of the light emission at each of a plurality of time points;
comparing a combination of the values indicative of the intensity of the light emission at each of the plurality of time points with stored data to determine an intensity score;
comparing a combination of the values indicative of the time derivative of intensity of the light emission at each of the plurality of time points with stored data to determine an intensity time derivative score; and
using both the intensity score and the intensity time derivative score to determine the characteristic of the aerosol-generating article.

Example Ex25. A method according to any preceding example, wherein analysing the light emission received by the light receiver comprises determining a value indicative of an intensity, or a value indicative of a time derivative of intensity, of the light emission at at least one characteristic time point occurring a predetermined length of time after the light source ends illuminating the aerosol-generating article.

Example Ex26. A method according to any preceding example, wherein analysing the light emission received by the light receiver comprises determining or estimating one or more traits of the light emission at a time point or at a plurality of time points.

Example Ex27. A method according to any preceding example, wherein analysing the light emission received by the light receiver comprises determining or estimating one or more traits of the light emission at each of n time points.

Example Ex28. A method according to example Ex26 or Ex27, wherein at least one of the one or more traits of the light emission at a time point is one of, or is a function of one or more of, an intensity of the light emission at that time point, a time first derivative of intensity of the light emission at that time point, a time second derivative of intensity of the light emission at that time point, and a time greater than second derivative of intensity of the light emission at that time point.

Example Ex29. A method according to any of examples Ex26-Ex28, wherein analysing the light emission received by the light receiver comprises one or both of: comparing a trait of the one or more traits with a corresponding threshold, for example a predetermined threshold, and determining whether a trait of the one or more traits falls within a corresponding range, for example predetermined range.

Example Ex30. A method according to any of examples Ex26-Ex29, wherein analysing the light emission received by the light receiver comprises one or both of: comparing a function of at least two traits of the one or more traits with a corresponding threshold, for example a predetermined threshold, and determining whether a function of at least two traits of the one or more traits falls within a corresponding range, for example predetermined ranges.

Example Ex31. A method according to any of examples Ex26-Ex30, wherein analysing the light emission received by the light receiver comprises comparing a first function of at least two traits of the one or more traits with a second function of at least two traits of the one or more traits.

Example Ex32. A method according to example Ex31, wherein the at least two traits involved in the first function overlap with the at least two traits involved in the second function.

Example Ex33. A method according to any preceding example, wherein analysing the light emission received by the light receiver comprises determining or estimating a time taken for a trait of the one or more traits to increase or decrease from a first level to a second level.

Example Ex34. A method according to example Ex33, wherein the second level is a function of the first level.

Example Ex35. A method according to any preceding example, wherein analysing the light emission received by the light receiver comprises one or both of collecting and recording data based on the light emission and comparing this data with predetermined reference data.

Example Ex36. A method according to example Ex35, when directly or indirectly dependent on Ex27, wherein the data is, comprises, or is based on, the one or more traits of the light emission determined or estimated at each of the n time points.

Example Ex37. A method according to any of examples Ex35-Ex36, wherein the reference data is, comprises, or is based on, one or more corresponding expected traits of the light emission, for example at each of the n time points.

Example Ex38. A method according to any preceding example, wherein analysing the light emission received by the light receiver comprises a trait determined or estimated at a particular time point being compared with a corresponding, expected trait at a corresponding time point.

Example Ex39. A method according to any preceding example, wherein analysing the light emission received by the light receiver comprises a trait determined or estimated at each of a plurality of, for example n, time points being compared with a corresponding, expected trait at each of a plurality of, for example n, corresponding time points.

Example Ex40. A method according to any preceding example, wherein analysing the light emission received by the light receiver comprises determining whether a determined or estimated trait falls within a range including a corresponding, expected trait.

Example Ex41. A method according to any preceding example, wherein analysing the light emission received by the light receiver comprises determining or estimating differences between determined or estimated traits at a plurality of, for example n, time points and corresponding, expected traits at a plurality of, for example n, corresponding time points.

Example Ex42. A method according to example Ex41, wherein analysing the light emission received by the light receiver comprises the differences, or a function of the differences such as a magnitude of these differences, being compared with a threshold.

Example Ex43. An aerosol-generating device configured to engage with, and disengage from, an aerosol-generating article comprising a taggant having an identifiable spectroscopic signature, the taggant being excitable by light to emit a light emission, the aerosol-generating device comprising:
a light source for illuminating an aerosol-generating article engaged with the device;
a light receiver for receiving light emitted by an aerosol-generating article engaged with the device; and
a controller, the controller being configured to:
activate the light source to illuminate the aerosol-generating article engaged with the aerosol-generating device so as to excite the taggant to emit the light emission;
deactivate the light source to end illuminating the aerosol-generating article engaged with the aerosol-generating device; and
analyse the light emission received by the light receiver after the light source ending illuminating the aerosol-generating article to determine a characteristic of the aerosol-generating article.

Example Ex44. An aerosol-generating device according to example Ex43, wherein the controller is configured to carry out the method of any of examples Ex1 to Ex42.

Example Ex45. A controller for an aerosol-generating device, the aerosol-generating device being configured to engage with, and disengage from, an aerosol-generating article comprising a taggant having an identifiable spectroscopic signature, the taggant being excitable by light to emit a light emission, and the aerosol-generating device comprising:
a light source for illuminating an aerosol-generating article engaged with the device; and
a light receiver for receiving light emitted by an aerosol-generating article engaged with the device,
the controller being configured to:
activate the light source to illuminate the aerosol-generating article engaged with the aerosol-generating device so as to excite the taggant to emit the light emission;
deactivate the light source to end illuminating the aerosol-generating article engaged with the aerosol-generating device; and
analyse the light emission received by the light receiver after the light source ending illuminating the aerosol-generating article to determine a characteristic of the aerosol-generating article.

Example Ex46. A controller according to example Ex45, wherein the controller is configured to carry out the method of any of examples Ex1 to Ex42.

Examples will now be further described with reference to the figures in which:

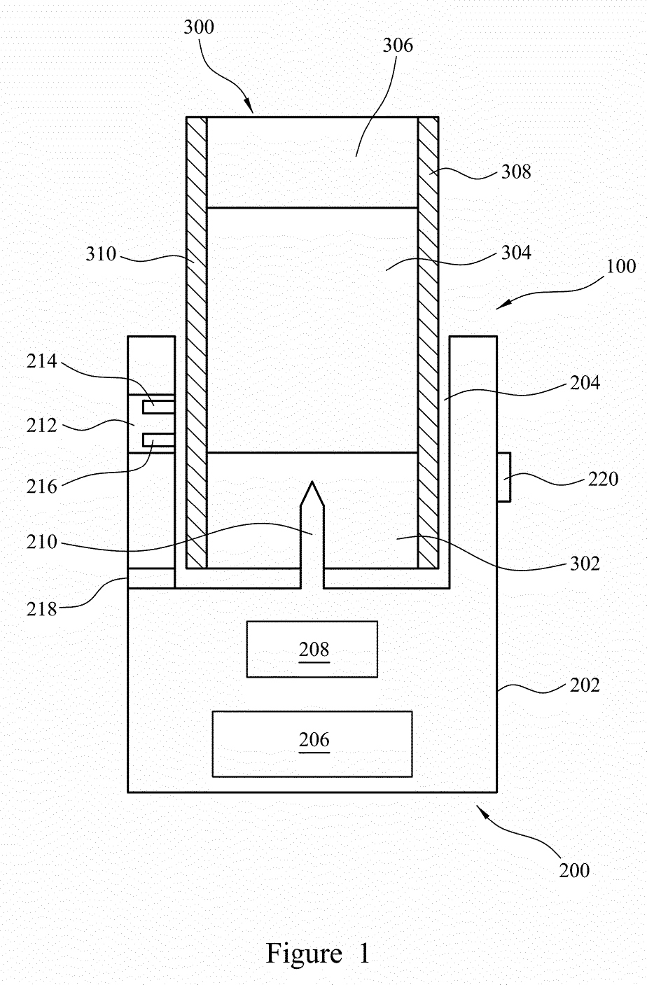

FIG. 1 shows an aerosol-generating system;

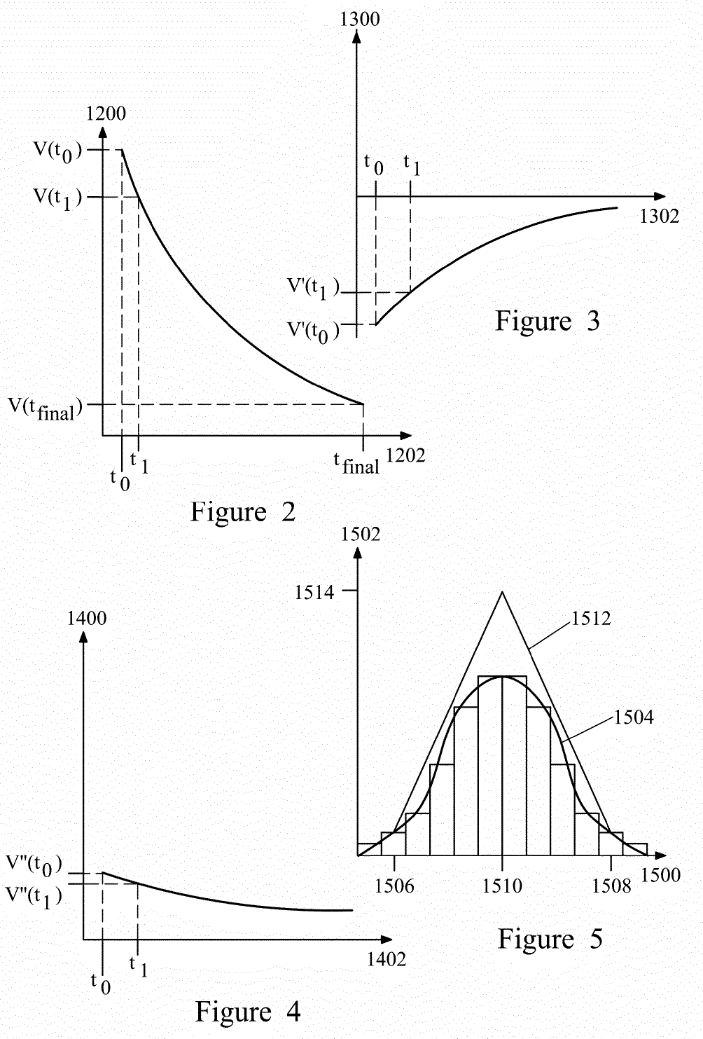

FIG. 2 shows a graph plotting a value indicative of an intensity of a light emission from a taggant against time;

FIG. 3 shows a graph plotting a value indicative of a time first derivative of intensity of a light emission from a taggant against time;

FIG. 4 shows a graph plotting a value indicative of a time second derivative of intensity of a light emission from a taggant against time;

FIG. 5 shows a graph visually depicting stored data and a scoring method;

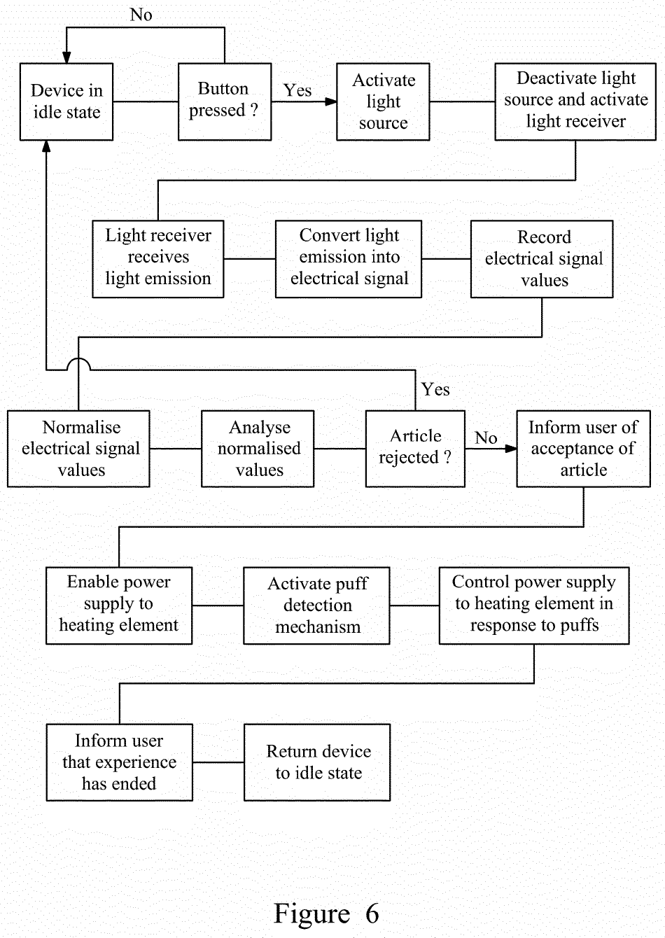

FIG. 6 shows a flow chart depicting the main steps of the method; and

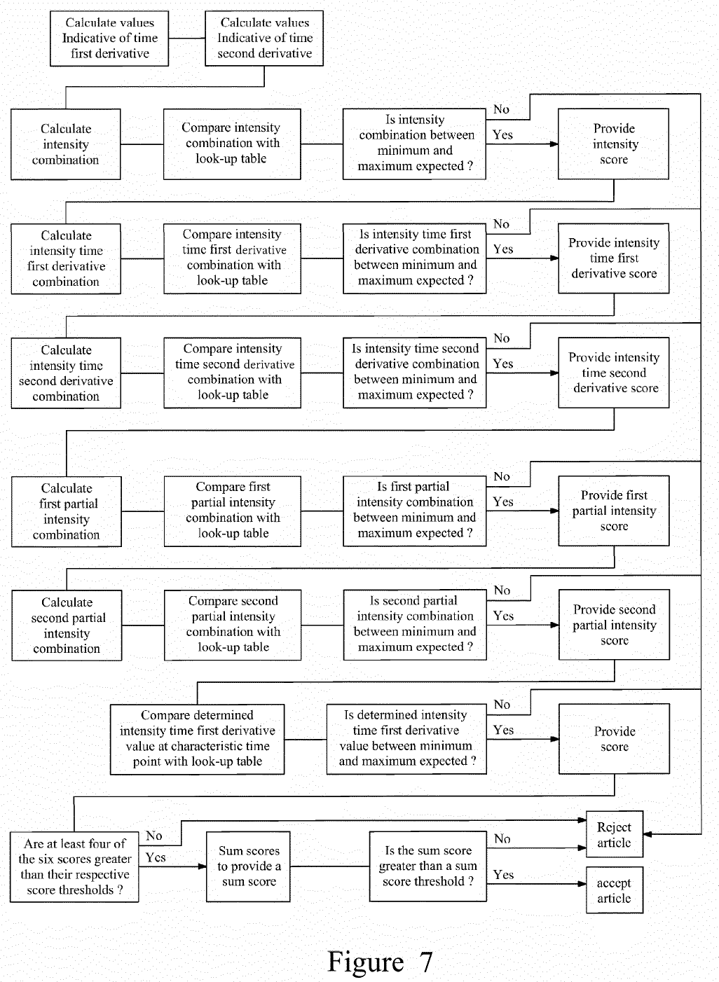

FIG. 7 shows a flow chart depicting the main steps of the step of analysing the light emission.

FIG. 1 shows an aerosol-generating system 100. The system 100 comprises an aerosol-generating device 200 and an aerosol-generating article 300.

The aerosol-generating device 200 comprises a housing 202 defining a cavity 204 for receiving a portion of the aerosol-generating article 300. In FIG. 1, the aerosol-generating article 300 is engaged with, or received in the cavity 204 of, the aerosol-generating device 200.

The device 200 comprises a power supply 206, a controller 208, and a substantially blade-shaped heating element 210. The heating element 210 comprises an electrically resistive track supported on a substrate. The controller 208 is connected to the power supply 206 and the heating element 210. The controller 208 controls a supply of current from the power supply 206 through the electrically resistive track of the heating element 210 to control heating of the heating element 210.

The device 200 comprises an identifier 212 comprising a light source 214, specifically an infrared light emitting diode (IR LED), and a light receiver 216, specifically a photodiode.

The device 200 further comprises an air inlet 218 for allowing air to flow into the cavity 204, and a button 220 which allows a user to operate the device 200.

The aerosol-generating article 300 comprises an aerosol-forming substrate 302, a hollow tubular transfer element 304, a mouthpiece 306 arranged sequentially within an outer wrapper 308. The outer wrapper 308 comprises a taggant 310 having an identifiable spectroscopic signature. The taggant 310 is incorporated in the wrapper during manufacturing of the wrapper material.

The wrapper material in this example is manufactured by incorporating the taggant 310 in powder form in the wrapper paper material slurry before the slurry is formed into paper and dried. The taggant 310 is thermally and chemically stable at the temperature and conditions used during manufacture such that the taggant 310 functions as desired in the assembled article 300. Alternatively, the taggant 310 may be applied to the wrapper material in a solution by spraying, printing, painting or the like.

The use of the taggant 310 incorporated within the material of the wrapper prevents the taggant 310 from being removed from the wrapper after manufacture. In this way, the tamper resistance of the article, and the difficulty of using non-optimised articles with the aerosol-generating device, may be improved.

The taggant 310 is excitable by light to emit a light emission. The time response of the taggant (that is, the change of the intensity of the light emission over time) is identifiable by a light receiver 216. The time response acts as a spectroscopic signature. Thus, identifying the spectroscopic signature of the taggant 310 may allow determination of at least one characteristic of the article 300.

Methods of controlling the aerosol-generating system 100 shall now be described.

Initially, the device 200 is in an idle state. The article 300 is then received in the cavity 204 of the device 200. The user then presses the button 220 on the device 200 to operate the identifier 212.

The pressing of the button 220 causes the controller 208 to send a signal to the light source 214, causing the light source 214 to illuminate the article 300 engaged with the device 200 with infrared light.

The taggant 310 is excited by this light so as to emit a light emission. The taggant 310 is configured to continue emitting this light emission for a time after excitation. In this embodiment, the taggant is configured to continue emitting the light emission for around 1 second after excitation.

The controller 208 then ends the illumination of the article 300 by the light source 214 and activates the light receiver 216.

The light receiver 216 then receives light emitted by the taggant 310. The light receiver 216 converts this received light into an electrical signal, specifically a voltage signal in which a voltage provided to the controller 208 is proportional to an intensity of the light received by the light receiver 216.

The controller 208 records a voltage value of the voltage signal, which is a value indicative of an intensity of the light emission from the taggant 310, and a corresponding time at each of a plurality of time points for a predetermined time period. The plurality of time points occur at regular time intervals of around 20 microseconds. The time period over which the plurality of time points occur is around 700 milliseconds.

The controller 208 then normalises the voltage values by dividing each recorded voltage value by the largest voltage value recorded. This provides a normalised voltage value of 1.

The first time point may be referred to as to, and the second time point may be referred to as t₁, and so on, up to the final time point t_{final}. The first normalised voltage value, which is the normalised voltage value corresponding to time point to, may be referred to as V(t₀). The second normalised voltage value, which is the normalised voltage value corresponding to time point t₁. may be referred to as V(t₁), and so on, up to the final normalised voltage value, which is the normalised voltage value corresponding to time point t_{final}, and may be referred to as V(t_{final}), In this case, the first voltage voltage value is the largest in the electrical signal, and the first normalised voltage value is thus equal to 1.

The controller 208 may then plot the normalised voltage values against time, which may be written mathematically as V(t), to obtain a graph like that shown in FIG. 2. The time points t₀, t₁, and t_{final}, along with their corresponding normalised voltage values V(t₀), V(t₁), and V(t_{final}), are shown in FIG. 2. For clarity, these points are shown spaced further apart than they actually are. However, given that the controller 208 has recorded the raw data on which this graph is based, there may be no need for the controller 208 to obtain such a graph, nor any graph which is based on the raw data.

The graph shown in FIG. 2 shows a time response of the taggant 310. Specifically, the graph shown in FIG. 2 plots the value 1200 indicative of the intensity of the light emission from the taggant 310 (the normalised voltage value) against time 1202 over the predetermined time period of 700 milliseconds from the light source 214 ending illuminating the article 300.

The controller 208 then calculates a value indicative of a time first derivative of intensity of the light emission from the taggant 310 at each of the plurality of time points. Each value is calculated as the difference between the subsequent normalised voltage value and the current normalised voltage value divided by the difference between the time point at which the subsequent normalised voltage value was measured and the time point at which the current normalised voltage value was measured. In this case, since the time intervals between time points are all 20 microseconds, this can be stated simply as the difference between the subsequent normalised voltage value and the current normalised voltage value divided by 20 microseconds. So the time first derivative at time t₀ is calculated as (V(t₀)−V(t₁)) divided by 20 microseconds.

The value indicative of the time first derivative at time t₀ may be referred to as V′(t₀), and the value indicative of the time first derivative at time t₁ may be referred to as V′(t₁), and so on. No value indicative of the time first derivative is calculated for the final time point since there is no subsequent normalised voltage value.

The controller 208 may plot these values indicative of the time first derivative of intensity of the light emission against time, which may be written mathematically as V′(t), to obtain a graph like that shown in FIG. 3. The time points t₀ and t₁ along with their corresponding intensity time first derivative values V′(t₀) and V′(t₁), are shown in FIG. 3. For clarity, these points are shown spaced further apart than they actually are. The graph shown in FIG. 3 plots the value 1300 indicative of the time first derivative of intensity of the light emission from the taggant 310 against time 1302 over the predetermined time period of 700 milliseconds from the light source 214 ending illuminating the article 300. The graph shown in FIG. 3 approximates a graph showing the rate of change of the graph shown in FIG. 2.

The controller 208 then calculates a value indicative of a time second derivative of intensity of the light emission from the taggant 310 at each of the plurality of time points. Each value is calculated as the difference between the subsequent value indicative of the first time derivative and the current value indicative of the first time derivative divided by 20 microseconds. So the time second derivative at time t₀ is calculated as (V′(t₀)−V′(t₁)) divided by 20 microseconds.

The value indicative of the time second derivative at time to may be referred to as V″(t₀), and the value indicative of the time second derivative at time t₁ may be referred to as V″(t₁), and so on. No value indicative of the time second derivative is calculated for the final or penultimate time point.

The controller 208 may plot these values indicative of time second derivative of intensity of the light emission against time, which may be written mathematically as V″(t), to obtain a graph like that shown in FIG. 4. The time points to and t₁ along with their corresponding intensity time second derivative values V″(t₀) and V″(t₁), are shown in FIG. 4. For clarity, these points are shown spaced further apart than they actually are. The graph shown in FIG. 4 plots the value 1400 indicative of the time second derivative of intensity of the light emission from the taggant 310 against time 1402 over the predetermined time period of 700 milliseconds from the light source 214 ending illuminating the article 300. The graph shown in FIG. 4 approximates a graph showing the rate of change of the graph shown in FIG. 3.

The controller 208 may calculate as many time derivatives of intensity of the light emission as necessary to aid identifying the spectroscopic signature of the taggant 310.

The controller 208 calculates an intensity combination by summing all of the values indicative of the intensity of the light emission (the normalised voltage values) at each of the plurality of time points. That is, the controller 208 calculates the intensity combination as:

$$\begin{matrix}intensity combination = {\sum }_{{t}_{n} = {t}_{initial} = {t}_{0}}^{{t}_{n} = {t}_{final}} V ( {t}_{n} ) \\ = V ( {t}_{0} ) + V ( {t}_{1} ) + V ( {t}_{2} ) … + V ( {t}_{final} )\end{matrix}$$

As explained earlier, this sum is merely one example of a particular intensity combination. The combination could be based on another sum, or a multiplication, or another function of the values indicative of the intensity of the light emission at each of the plurality of time points. The combination could be based on an estimate of an integral of the function plotting the values indicative of the intensity of the light emission at each of the plurality of time points against time. That is, the combination could be calculated as an integral of V(t) between to and t_{final}.

The controller 208 calculates an intensity time first derivative combination by summing all of the values indicative of the intensity time first derivative of the light emission at each possible time point. That is, the controller 208 calculates the intensity time first derivative combination as:

$$\begin{matrix}intensity time first derivative combination = {\sum }_{{t}_{n} = {t}_{initial} = {t}_{0}}^{{t}_{n} = {t}_{final - 1}} {V}^{′} ( {t}_{n} ) \\ = {V}^{′} ( {t}_{0} ) + {V}^{′} ( {t}_{1} ) + {V}^{′} ( {t}_{2} ) … + \\ {V}^{′} ( {t}_{final - 1} )\end{matrix}$$

The controller 208 calculates an intensity time second derivative combination by summing all of the values indicative of the intensity time second derivative of the light emission at each of the plurality of time points. That is, the controller 208 calculates the intensity time second derivative combination as:

$$\begin{matrix}intensity time second derivative combination = {\sum }_{{t}_{n} = {t}_{initial} = {t}_{0}}^{{t}_{n} = {t}_{final - 2}} {V}^{″} ( {t}_{n} ) \\ = {V}^{″} ( {t}_{0} ) + {V}^{″} ( {t}_{1} ) + \\ {V}^{″} ( {t}_{2} ) … + {V}^{″} ( {t}_{final - 2} )\end{matrix}$$

The controller 208 calculates a first partial intensity combination by summing all of the values indicative of the intensity of the light emission (the normalised voltage values) at each of the plurality of time points, up to the time point corresponding to 100 milliseconds after the predetermined time period started. That is, the controller 208 calculates the first partial intensity combination as:

$$\begin{matrix}first partial intensity combination = {\sum }_{{t}_{n} = {t}_{initial} = {t}_{0}}^{{t}_{n} = {t}_{100 ms}} V ( {t}_{n} ) \\ = V ( {t}_{0} ) + V ( {t}_{1} ) + V ( {t}_{2} ) … + V ( {t}_{300 ms} )\end{matrix}$$

This first partial intensity combination gives an indication of the time response of the taggant 310 during an initial portion of the light emission.

The controller 208 calculates a second partial intensity combination by summing all of the values indicative of the intensity of the light emission (the normalised voltage values) at each of the plurality of time points between the time point corresponding to 300 milliseconds after the predetermined time period started and the time point corresponding to 400 milliseconds after the predetermined time period started. That is, the e controller 208 calculates the second partial intensity combination as:

$$\begin{matrix}second partial intensity combination = {\sum }_{{t}_{n} = {t}_{300 ms}}^{{t}_{n} = {t}_{400 ms}} V ( {t}_{n} ) \\ = V ( {t}_{300 ms} ) + … + V ( {t}_{400 ms} )\end{matrix}$$

This second partial intensity combination gives an indication of the time response of the taggant 310 during an intermediate portion of the light emission.

The device 200 or controller 208 comprises stored data. The stored data includes, for a particular taggant, and for each of the five combinations set out above, a minimum expected combination, a maximum expected combination, an average or expected combination, and statistical dispersion data indicating a likelihood of a particular combination varying from the average or expected combination. The stored data comprises a score for each of a number of combinations from the minimum expected combination to the maximum expected combination. The scores are based on the statistical dispersion data. The highest score available corresponds to the average or expected combination. This information is stored in a look-up table. The look-up table could appear as follows:

| Combination | Score |
|---|---|
| Minimum expected combination = X | Score = 0.1 |
| . . . | . . . |
| Average or expected combination = Y | Score = 1 |
| . . . | . . . |
| Maximum expected combination = Z | Score = 0.1 |

As would be appreciated by the skilled person after reading this disclosure, the stored data could include that information for multiple taggants.

The controller 208 compares the intensity combination with a minimum expected intensity combination of the taggant. If the intensity combination is less than the minimum expected intensity combination of the taggant, the article is determined to be not optimised. Or, if the intensity combination is less than the minimum expected intensity combination of the taggant, the article is determined to be not configured for use with the device. If the article is determined to be not optimised or not configured for use with the device, the article may be rejected. In this context, rejecting the article may mean that the identifier 212 has determined that the article does not comprise a taggant which would indicate that the article 300 is configured for use with the device 200. Rejection may mean, for example, that the operation of the heating element 210 is disabled. Or, rejection may mean, for example, that the user is informed with a display (not shown) that the article 300 is not configured for use with the device 200. Or, rejection may mean, for example, that the heating element 210 is disabled and the user is informed with a display (not shown) that the article 300 is not configured for use with the device 200.

The controller 208 compares the intensity combination with a maximum expected intensity combination of the taggant. If the intensity combination is greater than the maximum expected intensity combination of the taggant, the article is rejected.

If the intensity combination falls between the minimum expected intensity combination and the maximum expected intensity combination, then the intensity combination is given an intensity score. The intensity score is greater the closer the intensity combination is to an expected or average intensity combination for the taggant. The intensity score is determined by determining which intensity combination in the look-up table is closest to the determined intensity combination, and then giving the determined intensity combination the intensity score corresponding to that intensity combination in the look-up table.

The controller 208 similarly compares each of the intensity time first derivative combination, the intensity time second derivative combination, the first partial intensity combination, and the second partial intensity combination, with their respective minimum and maximum expected combinations for the taggant. As with the intensity combination, if any combination is less than its minimum expected combination, or greater than its maximum expected combination, then the article is rejected.

Provided each of the five combinations falls between its minimum and maximum expected combination, then a score is received for each of the combinations. As with the intensity score, each score is greater the closer the combination is to an expected or average combination for the taggant. This is determined using the statistical dispersion data for each combination.

FIG. 5 shows an example of a graph visually depicting the stored data relating to the intensity combination and a scoring method of the determined intensity combination, as described above. To obtain the graph shown in FIG. 5, or at least the data underlying this graph, hundreds of tests were performed on different articles comprising the same taggant. Each test comprised illuminating an article with light from a light source similar to the light source 214 of the device 200, ending this illumination, and then analysing the light subsequently received by a light receiver similar to the light receiver 216 of the device 200. For each test, the intensity combination was recorded.

Each bar shown in FIG. 5 indicates a frequency that, during the hundreds of tests on different articles, an intensity combination fell within a particular range of intensity combinations. Specifically, on the X-axis 1500, the sides of each bar indicate the lower and upper limits of a particular range of intensity combinations, and, on the Y-axis 1502, the height of each bar is proportional to the number of articles which, when tested, returned an intensity combination within the particular range. A line 1504 has been plotted, based on these bars, to show the distribution of intensity combinations that were obtained. As is visible from FIG. 5, the intensity combinations obtained had a substantially normal, or Gaussian, distribution. This is an example of statistical dispersion data for the intensity combination.

The X-axis also shows a selected minimum expected intensity combination 1506. In this embodiment, the minimum expected intensity combination 1506 was selected such that only 1% of the articles had an intensity combination less than the minimum expected intensity combination 1506. The X-axis also shows a selected maximum expected intensity combination 1508. In this embodiment, the maximum expected intensity combination 1508 was selected such that only 1% of the articles had an intensity combination greater than the maximum expected intensity combination 1508. The X-axis also shows an average or expected intensity combination 1510. In this embodiment, the average or expected intensity combination 1510 coincides with the mean, median, and mode of the distribution since the distribution is substantially normal, or Gaussian.

A further line 1512 has also been plotted on the graph. The line 1512 shows the intensity score given for any particular determined intensity combination. For the line 1512, the X-axis 1500 indicates the intensity combination determined as set out above, and the Y-axis 1502 indicates the score given to the determined intensity combination. Thus, as can be seen from FIG. 5, the intensity score given to a particular article 300 is greater the closer the determined intensity combination is to the expected or average intensity combination 1510. The highest score available 1514 thus corresponds to the determined intensity combination being equal to the expected or average intensity combination 1510. As explained above, if the determined intensity combination is less than the minimum expected intensity combination 1506, or greater than the maximum expected intensity combination 1508, then the article 300 does not receive a score and is rejected.

The stored data has been explained above with reference to the data relating to the intensity of the light emission, and the intensity combination of the light emission. However, as would be understood by the skilled person after reading this disclosure, the stored data may comprise similar data relating to various other characteristics of the light emission, including for example any one or more of the intensity time first derivative combination, the intensity time second derivative combination, an intensity time greater than second derivative combination, the first partial intensity combination, the second partial intensity combination, a first partial intensity time derivative combination, a second partial intensity time derivative combination, and so on.

The stored data also includes, for the particular taggant, a minimum expected value indicative of the time first derivative of intensity of the light emission at a characteristic time point, a maximum expected value indicative of the time first derivative of intensity of the light emission at the characteristic time point, an average or expected value indicative of the time first derivative of intensity of the light emission at the characteristic time point, and statistical dispersion data indicating a likelihood of the value indicative of the time first derivative of intensity of the light emission at the characteristic time point varying from the average or expected value indicative of the time first derivative of intensity of the light emission at the characteristic time point.

The stored data comprises a score for each of a number of values from the minimum expected value to the maximum expected value. The scores are based on the statistical dispersion data. The highest score available corresponds to the average or expected value. This information is stored in a look-up table. The look-up table could appear as follows:

| Value | Score |
|---|---|
| Minimum expected value = X | Score = 0.1 |
| . . . | . . . |
| Average or expected value = Y | Score = 1 |
| . . . | . . . |
| Maximum expected value = Z | Score = 0.1 |

As would be appreciated by the skilled person after reading this disclosure, the stored data could include that information for multiple taggants.

In this particular case, the characteristic time point is 150 milliseconds after the light source ends illuminating the aerosol-generating article. Similarly to the combinations discussed above, the value indicative of the time first derivative of intensity of the light emission at this characteristic time point is compared with its minimum and maximum expected values for the taggant. As with the intensity combination, if the value indicative of the time first derivative of intensity of the light emission at the characteristic time point is less than its minimum expected value, or greater than its maximum expected value, then the article is rejected.

Provided the value indicative of the time first derivative of intensity of the light emission at the characteristic time point falls between its minimum and maximum expected values, then a score is received for the value indicative of the time first derivative of intensity of the light emission at this characteristic time point. As with the intensity score, the score is greater the closer the value is to the expected or average value for the taggant. The score is determined by determining which value in the look-up table is closest to the determined value, and then giving the determined value the score corresponding to that value in the look-up table. Thus, after these steps, assuming the article 300 has not been rejected, the controller 208 has determined six scores for the article 300.

Each of these six scores are then compared to a respective score threshold. In this embodiment, if two or more of the six scores fall below their respective score thresholds, the article is rejected.

Provided the article is not rejected, the six scores are then summed, in this embodiment each with equal weighting, to provide a sum score. This sum score is then compared with a sum score threshold. If the sum score is greater than the sum score threshold, then the controller 208 determines with a reasonable degree of certainty that the taggant 310 has the same spectroscopic signature as the taggant to which the stored data relates, and that the article 300 thus comprises the taggant to which the stored data relates, and that the article 300 is thus an optimised article which is configured for use with the device 200.

The controller 208 therefore informs the user that the article 300 has been accepted with the display (not shown), enables power to be supplied from the power supply 206 to the heating element 210, and activates a puff detection mechanism (not shown) of the device 200.

As would be appreciated by the skilled person after reading this disclosure, the stored data could comprise data relating to multiple taggants. In this case, the comparisons discussed above may be performed for each taggant to identify which of the multiple taggants, if any, is present in the article.

The user may then inhale on the article 300. This causes air to flow through the air inlet 218 and into the cavity 204. This inhalation is detected by the puff detection mechanism (not shown) of the device 200. The puff detection mechanism informs the controller 208 that a puff has been taken, and the controller 208 controls the power supply 206 to supply power to the heating element 210 accordingly. Specifically, power is sent to the heating element 210 so as to heat the heating element 210 and thus the article 300 so as to release volatile compounds from the aerosol-forming substrate 302. The air flows through the substrate 302 and entrains these compounds. The air and entrained compounds then flow through the tubular transfer element 304. The entrained compounds cool and condense so as to generate an aerosol. The aerosol is drawn through the mouthpiece 306 and into the mouth of the user. The user may then inhale the aerosol. The temperature of the heating element 210 is raised in response to each inhalation or puff on the article 300 in a similar manner, until the device 200 alerts the user that the experience has finished. This may occur a predetermined time after the first inhalation.

The device 200 may then return to the idle state, ready for the article 300 to be replaced by another, fresh article.

One particular method for analysing the light emission received by the light receiver 216 to identify the spectroscopic signature of the taggant 310 and determine a characteristic of the aerosol-generating article 300 has been described above. This method may be shown as a flow chart, as shown in FIG. 6 and summarised again below.

Initially, the device 200 is in an idle state. This is the initial position in the flow chart. The article 300 is then received in the cavity 204 of the device 200 and the user then presses the button 220 on the device 200.

In response to the pressing of the button 220, the controller 208 activates the light source 214 to illuminate the article 300 engaged with the device 200 with infrared light and excite the taggant 310.

The controller 208 then ends the illumination of the article 300 by deactivating the light source 214 and activates the light receiver 216.

The light receiver 216 then receives light emitted by the taggant 310.

The light receiver 216 converts this received light into an electrical signal, specifically a voltage signal in which a voltage provided to the controller 208 is proportional to an intensity of the light received by the light receiver 216.

The controller 208 records a voltage value of the voltage signal, which is a value indicative of an intensity of the light emission from the taggant 310, and a corresponding time for each of a plurality of time points over a predetermined time period.

The controller 208 then normalises the voltage values recorded.

The controller 208 then analyses the light emission, specifically the recorded, normalised voltage values of the electrical signal based on the light emission, to determine a characteristic of the article 300. For simplicity, in FIG. 6, this analysis is shown as a single step. However, this analysis involves multiple steps as set out below and shown separately in FIG. 7.

The controller 208 calculates a value indicative of a time first derivative of intensity of the light emission for each of a plurality of time points.

The controller 208 then calculates a value indicative of a time second derivative of intensity of the light emission for each of a plurality of time points.

The controller 208 then calculates an intensity combination of the light emission, based on the recorded normalised voltage values.

The controller 208 then compares the calculated intensity combination against an intensity combination-based look-up table. If the calculated intensity combination is less than a minimum expected intensity combination in the look-up table, or greater than a maximum expected intensity combination in the look-up table, then the article is rejected. Otherwise, the intensity combination is given an intensity score according to the look-up table.

The controller 208 then calculates an intensity time first derivative combination of the light emission, based on the values indicative of the time first derivative of intensity of the light emission at each of a plurality of time points.

The controller 208 then compares the calculated intensity time first derivative combination against an intensity time first derivative combination-based look-up table. If the calculated intensity time first derivative combination is less than a minimum expected intensity time first derivative combination in the look-up table, or greater than a maximum expected intensity time first derivative combination in the look-up table, then the article is rejected. Otherwise, the intensity time first derivative combination is given an intensity time first derivative score according to the look-up table.

The controller 208 then calculates an intensity time second derivative combination of the light emission, based on the values indicative of the time second derivative of intensity of the light emission at each of a plurality of time points.

The controller 208 then compares the calculated intensity time second derivative combination against an intensity time second derivative combination-based look-up table. If the calculated intensity time second derivative combination is less than a minimum expected intensity time second derivative combination in the look-up table, or greater than a maximum expected intensity time second derivative combination in the look-up table, then the article is rejected. Otherwise, the intensity time second derivative combination is given an intensity time second derivative score according to the look-up table.

The controller 208 then calculates a first partial intensity combination of the light emission, based on the values indicative of the intensity of the light emission at each of a plurality of time points.

The controller 208 then compares the calculated first partial intensity combination against a first partial intensity combination-based look-up table. If the calculated first partial intensity combination is less than a minimum expected first partial intensity combination in the look-up table, or greater than a maximum expected first partial intensity combination in the look-up table, then the article is rejected. Otherwise, the first partial intensity combination is given an first partial intensity score according to the look-up table.

The controller 208 then calculates a second partial intensity combination of the light emission, based on the values indicative of the intensity of the light emission at each of a plurality of time points.

The controller 208 then compares the calculated second partial intensity combination against a second partial intensity combination-based look-up table. If the calculated second partial intensity combination is less than a minimum expected second partial intensity combination in the look-up table, or greater than a maximum expected second partial intensity combination in the look-up table, then the article is rejected. Otherwise, the second partial intensity combination is given an second partial intensity score according to the look-up table.

A determined value indicative of the time first derivative of intensity of the light emission at a characteristic time point, which in this embodiment has already been calculated, is then compared with a value indicative of the time first derivative of intensity of the light emission at a characteristic time point-based look-up table. If the determined value is less than a minimum expected value in the look-up table, or greater than a maximum expected value in the look-up table, then the article is rejected. Otherwise, the determined value is given a score according to the look-up table.

At this stage, provided the article 300 has not been rejected, the controller 208 has obtained six scores.

Each of these six scores is then compared to a respective score threshold. In this embodiment, if two or more of the six scores fall below their respective score thresholds, the article is rejected.

Provided the article is not rejected, the six scores are then summed, in this embodiment each with equal weighting, to provide a sum score. This sum score is then compared with a sum score threshold. If the sum score is greater than the sum score threshold, then the controller 208 determines a characteristic of the article. Specifically, the controller 208 determines with a reasonable degree of certainty that the taggant 310 has the same spectroscopic signature as the taggant to which the stored data relates, and that the article 300 thus comprises the taggant to which the stored data relates, and that the article 300 is thus an optimised article which is configured for use with the device 200. This marks the end of the step of the controller 208 analysing the light emission, specifically the normalised voltage values of the electrical signal based on the light emission.

The controller 208 therefore informs the user that the article 300 has been accepted with the display (not shown), enables power to be supplied from the power supply 206 to the heating element 210, and activates a puff detection mechanism.

The user may then inhale on the article 300. This causes air to flow through the air inlet 218 and into the cavity 204.

This inhalation is detected using a puff detection mechanism (not shown) of the device 200. The puff detection mechanism informs the controller 208 that a puff has been taken, and the controller 208 controls the power supply 206 to supply power to the heating element 210 accordingly. Specifically, power is sent to the heating element 210 so as to heat the heating element 210 and thus the article 300 so as to release volatile compounds from the aerosol-forming substrate 302. The air flows through the substrate 302 and entrains these compounds. The air and entrained compounds then flow through the tubular transfer element 304. The entrained compounds cool and condense so as to generate an aerosol. The aerosol is drawn through the mouthpiece 306 and into the mouth of the user. The user may then inhale the aerosol. The temperature of the heating element 210 is raised in response to each inhalation or puff on the article 300 in a similar manner, until the device 200 alerts the user that the experience has finished. This may occur a predetermined time after the first inhalation.

The device 200 may then return to the idle state, ready for the article 300 to be replaced by another, fresh article. One particular method for analysing the light emission received by the light receiver 216 to identify the spectroscopic signature of the taggant 310 and determine a characteristic of the aerosol-generating article 300 has been described above. In this method, six scores were obtained and compared against six individual score thresholds. In addition, the six scores were summed and the sum was compared with a threshold. However, as would be understood by the skilled person after reading this disclosure, many other methods are possible.

For example, the method could comprise weighting scores differently. The method could comprise calculating more than one sum, for example a first sum of three scores, a second sum of three different scores, and a third sum of five scores, the third sum having overlapping scores with both the first sum and the second sum, and comparing those sums against respective thresholds. The article 300 could be rejected if all three sums are lower than their respective thresholds, or if two or more of the sums are lower than their respective thresholds, or if one or more of the sums are lower than their respective thresholds. Different combinations, for example any of the combinations described herein, could be used. Different scoring techniques could be used.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-16. (canceled)

17. A method of controlling an aerosol-generating system,
the aerosol-generating system comprising:
an aerosol-generating article comprising a taggant having an identifiable spectroscopic signature, the taggant being excitable by light to emit a light emission, and
an aerosol-generating device configured to engage with, and disengage from, the aerosol-generating article, the aerosol-generating device comprising:
a light source configured to illuminate the aerosol-generating article engaged with the aerosol-generating device, and
a light receiver configured to receive light emitted by the aerosol-generating article engaged with the aerosol-generating device; and
the method comprising:
illuminating, by the light source, the aerosol-generating article engaged with the aerosol-generating device so as to excite the taggant to emit the light emission,
ending the illuminating, by the light source, of the aerosol-generating article engaged with the aerosol-generating device,
receiving, by the light receiver, the light emission after the light source ending the illuminating of the aerosol-generating article, and
analysing the light emission received by the light receiver to determine a characteristic of the aerosol-generating article.

18. The method according to claim 17, wherein the analysing the light emission received by the light receiver comprises analysing an intensity of the light emission over time.

19. The method according to claim 17, wherein the analysing the light emission received by the light receiver comprises analysing a time derivative of intensity of the light emission over time.

20. The method according to claim 17, wherein the analysing the light emission received by the light receiver comprises analysing at least two different time derivatives of intensity of the light emission over time.

21. The method according to claim 17, wherein the analysing the light emission received by the light receiver comprises analysing both an intensity of the light emission over time and at least one time derivative of intensity of the light emission over time.

22. The method according to claim 17, wherein the analysing the light emission received by the light receiver comprises converting the light emission received by the light receiver into an electrical signal indicative of an intensity of the light emission over time.

23. The method according to claim 17, wherein the analysing the light emission received by the light receiver comprises determining a value indicative of an intensity of the light emission at each of a plurality of time points.

24. The method according to claim 23, wherein the analysing the light emission received by the light receiver further comprises comparing a combination of the values indicative of the intensity of the light emission at each of the plurality of time points with stored data.

25. The method according to claim 17, wherein the analysing the light emission received by the light receiver comprises determining a value indicative of a time derivative of intensity of the light emission at each of a plurality of time points, and comparing a combination of the values indicative of the time derivative of intensity of the light emission at each of the plurality of time points with stored data.

26. The method according to claim 17, wherein the analysing the light emission received by the light receiver comprises determining a value indicative of an intensity, or a time derivative of intensity, of the light emission at at least one characteristic time point occurring a predetermined length of time after the light source ends the illuminating of the aerosol-generating article.

27. The method according to claim 17, wherein the analysing the light emission received by the light receiver comprises:
determining or estimating one or more traits of the light emission at a time point or at each of n time points, and
one or both of:
comparing a trait of the one or more traits with a corresponding threshold, and
determining whether the trait of the one or more traits falls within a corresponding range.

28. The method according to claim 17, wherein the analysing the light emission received by the light receiver comprises:
determining or estimating one or more traits of the light emission at each of n time points,
and one or more of:
comparing a function of at least two traits of the one or more traits with a corresponding threshold,
comparing a first function of at least two traits of the one or more traits with a second function of at least two traits of the one or more traits, and
determining whether a function of at least two traits of the one or more traits falls within a corresponding range.

29. The method according to claim 17, wherein the analysing the light emission received by the light receiver comprises:
determining or estimating one or more traits of the light emission at a time point or at each of n time points, and
determining or estimating a time taken for a trait of the one or more traits to increase or decrease from a first level to a second level.

30. The method according to claim 17, wherein the analysing the light emission received by the light receiver comprises:
one or both of collecting and recording data based on the light emission, and
comparing the data with predetermined reference data.

31. An aerosol-generating device configured to engage with, and disengage from, an aerosol-generating article comprising a taggant having an identifiable spectroscopic signature, the taggant being excitable by light to emit a light emission, the aerosol-generating device comprising:
a light source configured to illuminate the aerosol-generating article engaged with the aerosol-generating device;
a light receiver configured to receive light emitted by the aerosol-generating article engaged with the aerosol-generating device; and
a controller configured to:
activate the light source to illuminate the aerosol-generating article engaged with the aerosol-generating device so as to excite the taggant to emit the light emission to be received by the light receiver,
deactivate the light source to end the illuminating of the aerosol-generating article engaged with the aerosol-generating device, and
analyse the light emission received by the light receiver after the light source ending the illuminating of the aerosol-generating article to determine a characteristic of the aerosol-generating article.

32. A controller for an aerosol-generating device, the aerosol-generating device being configured to engage with, and disengage from, an aerosol-generating article comprising a taggant having an identifiable spectroscopic signature, the taggant being excitable by light to emit a light emission, and the aerosol-generating device comprising a light source configured to illuminate the aerosol-generating article engaged with the aerosol-generating device, and a light receiver configured to receive light emitted by the aerosol-generating article engaged with the aerosol-generating device, the controller being configured to:
activate the light source to illuminate the aerosol-generating article engaged with the aerosol-generating device so as to excite the taggant to emit the light emission,
deactivate the light source to end the illuminating of the aerosol-generating article engaged with the aerosol-generating device, and
analyse the light emission received by the light receiver after the light source ending the illuminating of the aerosol-generating article to determine a characteristic of the aerosol-generating article.
